(19) United States
(12) Patent Application Publication
(10) Pub. No.: US 2020/0133226 A1
(43) Pub. Date: Apr. 30, 2020

(54) OUTPUT DEVICE, CONTROL DEVICE AND METHOD OF OUTPUTTING LEARNING PARAMETER

(71) Applicant: FANUC CORPORATION, Minamitsuru-gun (JP)

(72) Inventors: Ryoutarou TSUNEKI, Yamanashi (JP); Satoshi IKAI, Yamanashi (JP); Takaki SHIMODA, Yamanashi (JP)

(21) Appl. No.: 16/563,116

(22) Filed: Sep. 6, 2019

(30) Foreign Application Priority Data
Oct. 25, 2018 (JP) 2018-200820

(51) Int. Cl. G05B 19/402; G06N 20/00

(52) U.S. Cl. CPC G05B 19/402; G05B 2219/35524; G06N 20/00

(57) ABSTRACT

An output device includes: an information acquisition unit which acquires, from a machine learning device that performs machine learning on a servo control device for controlling a servo motor driving the axis of a machine tool, a robot or an industrial machine, a parameter or a first physical quantity of a constituent element of the servo control device that is being learned or has been learned; and an output unit which outputs at least one of any one of the acquired first physical quantity and a second physical quantity determined from the acquired parameter, a time response characteristic of the constituent element of the servo control device and a frequency response characteristic of the constituent element of the servo control device, and the time response characteristic and the frequency response characteristic are determined with the parameter, the first physical quantity or the second physical quantity.

This application is based on and claims the benefit of priority from Japanese Patent Application No. 2018-200820, filed on 25 Oct. 2018, the content of which is incorporated herein by reference.

### BACKGROUND OF THE INVENTION

### Field of the Invention

The present invention relates to an output device, a control device and a method of outputting learning parameters, and more particularly relates to an output device which acquires, from a machine learning device that performs machine learning on a servo control device for controlling a servo motor, parameters (referred to as learning parameters) that are being machine learned or have been machine learned and which outputs, from the learning parameters, information that is easily understood by a user such as an operator, to a control device which includes such an output device and to a method of outputting the learning parameters.

### Related Art

As a technology related to the present invention, for example, patent document 1 discloses a signal converter which includes an output unit that uses a multiplication coefficient pattern mastering method with a machine learning means so as to determine an intended multiplication coefficient pattern, that uses the multiplication coefficient pattern so as to perform a digital filter operation and that displays a digital filter output.

Specifically, patent document 1 discloses that the signal converter includes a signal input unit, an operation processing unit which has the function of characterizing signal data based on input signal data and the output unit which displays an output from the operation processing unit, that the operation processing unit includes an input file, a learning means, a digital filter and a parameter setting means and that in the learning means, the multiplication coefficient pattern mastering method is used with the machine learning means so as to determine the intended multiplication coefficient pattern.
Patent Document 1: Japanese Unexamined Patent Application, Publication No. H11-31139

### SUMMARY OF THE INVENTION

Disadvantageously, although in patent document 1, the output from the operation processing unit is displayed, a pattern which is machine learned with the machine learning means is not output, and thus a user such as an operator cannot check the progress or the result of the machine learning. When control parameters of a servo control device which controls a servo motor that drives the axis of a machine tool, a robot or an industrial machine are machine learned with a machine learning device, since learning parameters and an evaluation function value used in the machine learning device are not generally displayed, a user cannot check the progress or the result of the machine learning. Even when the learning parameters or the evaluation function value is displayed, the user has difficulty in understanding, from the learning parameters, how the characteristic of the servo control device is optimized.

An object of the present invention is to provide an output device which acquires learning parameters and which outputs, from the learning parameters, information that is easily understood by a user such as an operator, a control device which includes such an output device and a method of outputting the learning parameters.

(1) An output device (for example, an output device 200, 200A, 210 which will be described later) according to the present invention includes: an information acquisition unit (for example, an information acquisition unit 211 which will be described later) which acquires, from a machine learning device (for example, a machine learning device 200, 210 which will be described later) that performs machine learning on a servo control device (for example, a servo control device 300, 310 which will be described later) for controlling a servo motor (for example, a servo motor 400, 410 which will be described later) driving the axis of a machine tool, a robot or an industrial machine, a parameter or a first physical quantity of a constituent element of the servo control device that is being learned or has been learned; and an output unit (for example, a control unit 215 and a display unit 219, a control unit 215 and a storage unit 216 which will be described later) which outputs at least one of any one of the acquired first physical quantity and a second physical quantity determined from the acquired parameter, a time response characteristic of the constituent element of the servo control device and a frequency response characteristic of the constituent element of the servo control device and the time response characteristic and the frequency response characteristic are determined with the parameter, the first physical quantity or the second physical quantity.

(2) In the output device of (1) described above, the output unit may include a display unit which displays, on a display screen, the first physical quantity, the second physical quantity, the time response characteristic or the frequency response characteristic.

(3) In the output device of (1) or (2) described above, an instruction to adjust the parameter or the first physical quantity of the constituent element of the servo control device based on the first physical quantity, the second physical quantity, the time response characteristic or the frequency response characteristic may be provided to the servo control device.

(4) In the output device of any one of (1) to (3) described above, a machine learning instruction to perform, by changing or selecting a learning range, the machine learning of the parameter or the first physical quantity of the constituent element of the servo control device based on the first physical quantity, the second physical quantity, the time response characteristic or the frequency response characteristic may be provided to the machine learning device.

(5) In the output device of any one of (1) to (4) described above, an evaluation function value which is used in the learning of the machine learning device may be output.

(6) In the output device of any one of (1) to (5) described above, information on a position error which may be output from the servo control device is output.

(7) In the output device of any one of (1) to (6) described above, the parameter of the constituent element of the servo control device may be a parameter of a mathematical formula model or a filter.

(8) In the output device of any one of (1) to (7) described above, the mathematical formula model or the filter may be included in a velocity feedforward processing unit or a position feedforward processing unit, and the parameter may include a coefficient in a transfer function of the filter.

(9) A control device according to the present invention includes: the output device of any one of (1) to (8) described above; the servo control device which controls the servo motor that drives the axis of the machine tool, the robot or the industrial machine; and the machine learning device which performs the machine learning on the servo control device.

(10) In the control device of (9) described above, the output device may be included in one of the servo control device, the machine learning device and a numerical control device.

(11) A method of outputting a learning parameter of an output device according to the present invention is a method of outputting a parameter which is machine learned in a machine learning device for a servo control device that controls a servo motor for driving the axis of a machine tool, a robot or an industrial machine, and includes: acquiring, from the machine learning device, a parameter or a first physical quantity of a constituent element of the servo control device which is being learned or has been learned; outputting at least one of any one of the acquired first physical quantity and a second physical quantity determined from the acquired parameter, a time response characteristic of the constituent element of the servo control device and a frequency response characteristic of the constituent element of the servo control device; and determining the time response characteristic and the frequency response characteristic with the parameter, the first physical quantity or the second physical quantity.

According to the present invention, parameters which are being machine learned or have been machine learned are acquired and are changed into information that is easily understood by a user such as an operator, and the information can be outputted.

### BRIEF DESCRIPTION OF THE DRAWINGS

FIG. 1 is a block diagram showing an example of the configuration of a control device according to a first embodiment of the present invention;

FIG. 2 is a block diagram showing the entire configuration of a control device and the configuration of a servo control device in a first example;

FIG. 3 is a diagram showing a velocity command serving as an input signal and a detection velocity serving as an output signal;

FIG. 4 is a diagram showing the frequency characteristics of an amplitude ratio between the input signal and the output signal and a phase delay;

FIG. 5 is a block diagram showing a machine learning device according to the first embodiment of the present invention;

FIG. 6 is a diagram showing a reference model of a servo control device which has an ideal characteristic without resonance;

FIG. 7 is a characteristic chart showing the frequency characteristics of the input/output gains of the servo control device of the reference model and the servo control device before and after learning;

FIG. 8 is a block diagram showing an example of the configuration of an output device included in the control device according to the first example of the present invention;

FIG. 9A is a characteristic chart showing an evaluation function value which is being machine learned and the progress of the minimum value of the evaluation function value and a diagram showing an example of a display screen when the values of control parameters which are being learned are displayed;

FIG. 9B is a diagram showing an example of a display screen when the physical quantities of the control parameters related to a state S are displayed in a display unit while machine learning is being performed so as to correspond to the progress of the machine learning;

FIG. 10 is a flowchart showing the operation of the control device after the start of the machine learning until the completion of the machine learning while focusing attention on the output device in the first example of the present invention;

FIG. 11 is a block diagram showing the entire configuration of a control device and the configuration of a servo control device according to a second example of the present invention;

FIG. 12 is a diagram showing a case where a machined shape specified by a learning machining program is an octagon;

FIG. 13 is a diagram showing a case where the machined shape is a shape in which the corners of an octagon are alternately replaced with arcs;

FIG. 14 is a diagram showing a complex plane indicating the search range of a pole and a zero point;

FIG. 15 is a diagram showing a frequency response characteristic chart of a velocity feedforward processing unit and a characteristic chart of a position error;

FIG. 16 is a flowchart showing the operation of an output device after an instruction to complete machine learning in the second example of the present invention;

FIG. 17 is a diagram showing a frequency response characteristic chart of the velocity feedforward processing unit and a characteristic chart of the position error when a center frequency is changed;

FIG. 18 is a diagram showing a case where the velocity feedforward processing unit is formed with a motor reverse characteristic, a notch filter and a low-pass filter;

FIG. 19 is a block diagram showing an example of the configuration of a control device according to a second embodiment of the present invention;

FIG. 20 is a block diagram showing an example of the configuration of a control device according to a third embodiment of the present invention; and

FIG. 21 is a block diagram showing a control device which has another configuration.

### DETAILED DESCRIPTION OF THE INVENTION

Embodiments of the present invention will be described in detail below with reference to drawings.

### First Embodiment

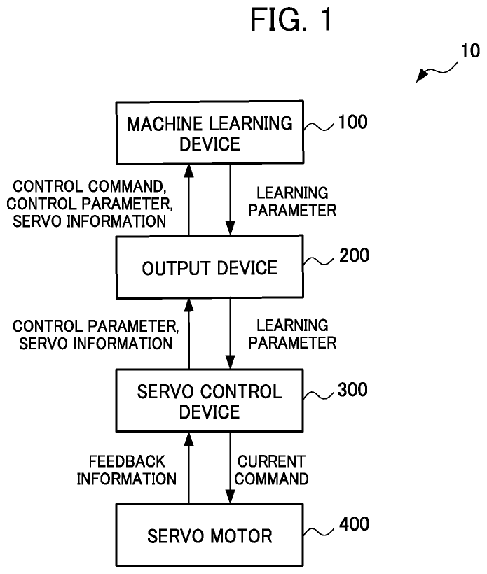

FIG. 1 is a block diagram showing an example of the configuration of a control device according to a first embodiment of the present invention. The control device 10 shown in FIG. 1 includes a machine learning device 100, an output device 200, a servo control device 300 and a servo motor 400. The machine learning device 100 acquires, from the output device 200, control commands such as a position command and a velocity command which are input to the servo control device 300 and servo information such as a position error which is output from the servo control device 300 or information which is used in machine learning such as information (for example, an input/output gain and a phase delay) obtained from the control commands and the servo information. FIG. 1 shows an example where the machine learning device 100 acquires the control commands and the servo information. The machine learning device 100 also acquires, from the output device 200, parameters of a mathematical formula model or parameters of a filter output from the servo control device 300. The machine learning device 100 machine-learns, based on the information which is input, the parameters of the mathematical formula model or the filter of the servo control device 300 so as to output learning parameters of the mathematical formula model or the filter to the output device 200. The learning parameters are, for example, coefficients of a notch filter provided in the servo control device 300 or coefficients of a velocity feedforward processing unit. Although in the description of the present embodiment, the machine learning device 100 performs reinforcement learning, the learning which is performed by the machine learning device 100 is not particularly limited to the reinforcement learning, and the present invention can also be applied to, for example, a case where supervised learning is performed.

The output device 200 acquires the learning parameters of the mathematical formula model or the filter which are being machine learned or have been machine learned in the machine learning device 100, and outputs, from the learning parameters, information indicating a physical quantity, a time response or a frequency response which is easily understood by a user such as an operator. Examples of the outputting method include screen display in a liquid crystal display device, printing using a printer or the like to paper, storage in a storage unit such as a memory and the output of an external signal through a communication unit.

When the learning parameters of the mathematical formula model or the filter are, for example, the coefficient of the notch filter or the coefficient of the velocity feedforward processing unit, even if the operator sees it itself, it is difficult to grasp the characteristic of the notch filter or the velocity feedforward processing unit, and it is also difficult to grasp how the characteristic is optimized by learning with the machine learning device. When the machine learning device 100 performs the reinforcement learning, though an evaluation function value for giving a reward can be output to the output device 200, it is difficult to grasp, with only the evaluation function value, how the parameters are optimized. Hence, the output device 200 outputs information which is easily understood by the user and which indicates the physical quantities of the parameters (for example, a center frequency, a bandwidth fw and an attenuation coefficient (damping)) or the time response or the frequency response of the mathematical formula model or the filter. As described above, the output device 200 outputs the information which is easily understood by the user such that the operator can easily understand the progress and the result of the machine learning. When the learning parameter itself which is output from the machine learning device 110 is a physical quantity that is easily understood by the user, the output device outputs the information thereof whereas when the learning parameter is information which is not easily understood by the user, the output device changes the information into the physical quantity or the time response or the frequency response of the mathematical formula model or the filter which is easily understood by the user, and outputs it. The physical quantity is any one of, for example, inertia, mass, viscosity, stiffness, a resonance frequency, an attenuation center frequency, an attenuation rate, an attenuation frequency range, a time constant, a cutoff frequency or a combination thereof.

The output device 200 also functions as an adjustment device which performs the relay of information (such as the control commands, control parameters and the servo information) between the machine learning device 100 and the servo control device 300 and the control of an operation between the machine learning device 100 and the servo control device 300.

The servo control device 300 outputs, based on the control commands such as the position command and the velocity command, a current command so as to control the rotation of the servo motor 400. The servo control device 300 includes the velocity feedforward processing unit which is represented by, for example, the notch filter or the mathematical formula model. The servo motor 400 is included in, for example, a machine tool, a robot or an industrial machine. The control device 10 may be included in a machine tool, a robot, an industrial machine or the like. The servo motor 400 outputs, to the servo control device 300, a detection position and/or a detection velocity as feedback information.

A specific configuration of the control device of the first embodiment will be described below based on first to fourth examples.

### First Example

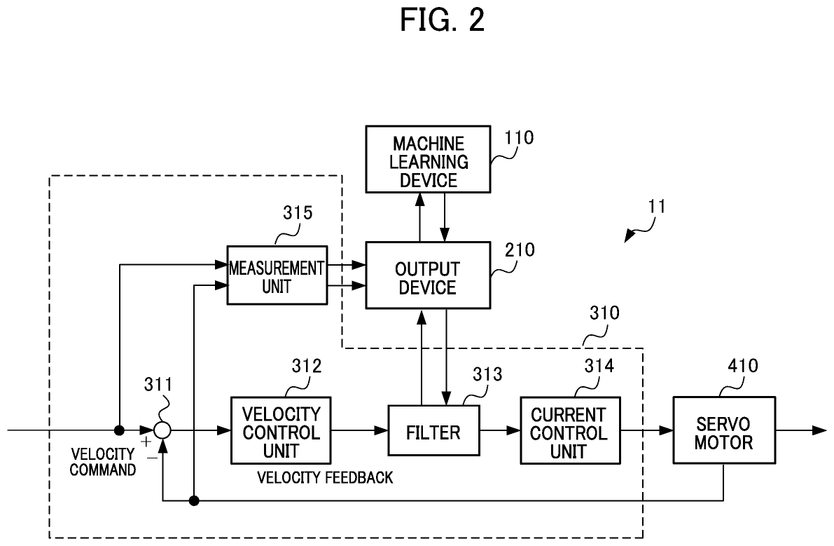

The present example is an example where a machine learning device 110 learns the coefficient of a filter included in a servo control device 310, and where an output device 210 displays, in a display unit, the progress of the frequency response of the filter. FIG. 2 is a block diagram showing the entire configuration of a control device and the configuration of the servo control device in the first example. The control device 11 includes the machine learning device 110, the output device 210, the servo control device 310 and a servo motor 410. The machine learning device 110, the output device 210, the servo control device 310 and the servo motor 410 shown in FIG. 2 correspond to the machine learning device 100, the output device 200, the servo control device 300 and the servo motor 400 in FIG. 1. One or all of the machine learning device 110 and the output device 210 may be provided within the servo control device 310.

The servo control device 310 includes, as constituent elements, a subtractor 311, a velocity control unit 312, a filter 313, a current control unit 314 and a measurement unit 315. The measurement unit 315 may be provided outside the servo control device 310. The subtractor 311, the velocity control unit 312, the filter 313, the current control unit 314 and the servo motor 410 configure a velocity feedback loop.

The subtractor 311 determines a difference between a velocity command which is input and a detection velocity which is subjected to velocity feedback, and outputs the difference to velocity control unit 312 as a velocity error. A sinusoidal signal whose frequency is changed is input as the velocity command to the subtractor 311 and the measurement unit 315. Although the sinusoidal signal whose frequency is changed is input from a high-level device, the servo control device 310 may include a frequency generation unit that generates the sinusoidal signal whose frequency is changed. The velocity control unit 312 adds a value obtained by multiplying the velocity error by an integral gain K1v and integrating the resulting value and a value obtained by multiplying the velocity error by a proportional gain K2v, and outputs the obtained value to the filter 313 as a torque command.

The filter 313 is a filter which attenuates a specific frequency component, and, for example, a notch filter is used. In a machine such as a machine tool which is driven with a motor, a resonance point is present, and resonance may be increased in the servo control device 310. The notch filter is used, and thus the resonance can be reduced. An output of the filter 313 is output as the torque command to the current control unit 314. Expression 1 (hereinafter represented as mathematical 1) indicates a transfer function G(s) of the filter 313. Control parameters are coefficients a₀, a₁, a₂, b₀, b₁ and b₂. When the filter is the notch filter, b₀=a₀ and b₂=a₂=1.

$$G ( s ) = \frac{{b}_{0} + {b}_{1} s + {b}_{2} {s}^{2}}{{a}_{0} + {a}_{1} s + {a}_{2} {s}^{2}} \qquad [ Math . 1 ]$$

In the following description, it is assumed that the filter is the notch filter, that in Expression 1, b₀=a₀ and b₂=a₂=1 and that the machine learning device 110 machine-learns the coefficients a₀, a₁ and b₁.

The current control unit 314 generates, based on the torque command, the current command for driving the servo motor 410, and outputs the current command to the servo motor 410. The rotational angular position of the servo motor 410 is detected with a rotary encoder (not shown) provided in the servo motor 410, and a velocity detection value is input to the subtractor 311 as velocity feedback.

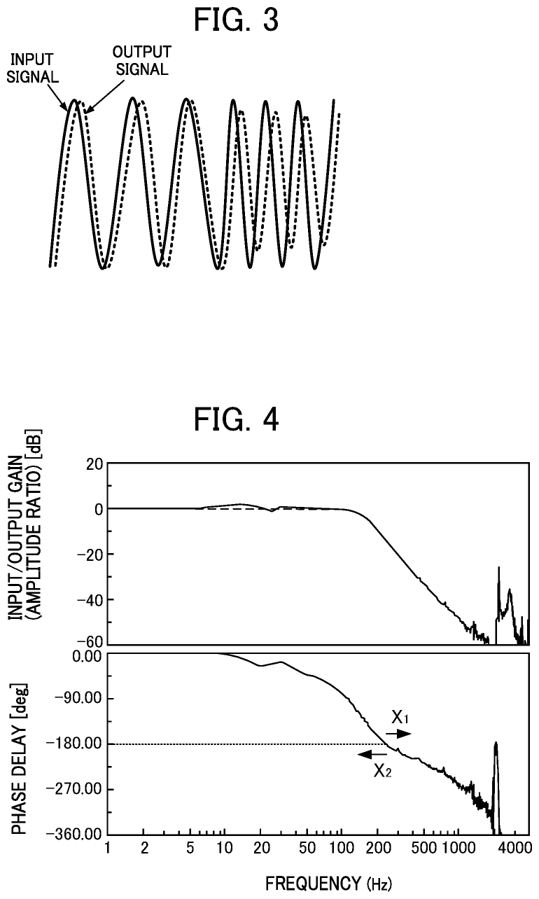

The sinusoidal signal whose frequency is changed is input to the measurement unit 315 as the velocity command. The measurement unit 315 uses the velocity command (sinusoidal wave) serving as an input signal and the detection velocity (sinusoidal wave) serving as an output signal output from the rotary encoder (not shown) so as to determine, for each frequency specified by the velocity command, an amplitude ratio (input/output gain) between the input signal and the output signal and a phase delay. FIG. 3 is a diagram showing the velocity command serving as the input signal and the detection velocity serving as the output signal. FIG. 4 is a diagram showing the frequency characteristics of the amplitude ratio between the input signal and the output signal and the phase delay. Although the servo control device 310 is configured as described above, in order to machine-learn the optimum parameters for the filter so as to output the frequency response of the parameters, the control device 11 further includes the machine learning device 110 and the output device 210.

The machine learning device 110 uses the input/output gain (amplitude ratio) and the phase delay output from the output device 210 so as to machine-learn (hereinafter referred to as learn) the coefficients a₀, a₁ and b₁ in the transfer function of the filter 313. Although the learning by the machine learning device 110 is performed before a shipment, relearning may be performed after the shipment.

The configuration and the details of the operation of the machine learning device 110 will further be described below. Before the description of individual function blocks included in the machine learning device 110, the basic mechanism of the reinforcement learning will first be described. An agent (which corresponds to the machine learning device 110 in the present embodiment) observes the state of an environment, and selects a certain action, and thus the environment is changed based on the action. As the environment is changed, any reward is provided, and thus the agent learns the selection (decision) of a better action. While the supervised learning indicates a perfect answer, the reward in the reinforcement learning is often a fragmentary value based on the change of part of the environment. Hence, the agent performs learning so as to select such an action that the total of rewards in the future is maximized.

In this way, in the reinforcement learning, the action is learned, and thus a method is learned of learning an appropriate action with consideration given to a mutual effect provided by the action to the environment, that is, a method is learned of performing learning for maximizing rewards obtained in the future. In the present embodiment, for example, this indicates that action information for reducing the vibration of a machine end is selected, that is, that an action affecting the future can be acquired.

Although here, as the reinforcement learning, an arbitrary learning method can be used, in the following discussion, a case where Q-learning which is a method of learning a value Q (S, A) of selecting an action A is used under the state S of a certain environment will be described as an example. An objective of the Q-learning is to select, among actions A which can be taken in a certain state S, an action A whose value Q (S, A) is the highest as an optimum action.

However, when the Q-learning is first started, in a combination of the state S and the action A, a proper value of the value Q (S, A) is not found at all. Hence, the agent selects various actions A under the certain state S, and selects a better action based on a reward provided for the action A at that time so as to learn the proper value Q (S, A).

Since the total of rewards which can be obtained in the future is desired to be maximized, the final aim is to achieve Q (S, A)=E[Σ(γ^{t})rₜ]. Here, E[ ] represents an expected value, t represents time, γ represents a parameter called a discount rate which will be described later, rₜ represents a reward at the time t and Σrepresents a total at the time t. The expected value in this formula is an expected value when the state is changed according to the optimum action. However, since in the process of the Q-learning, it is not clear what the optimum action is, various actions are performed, and thus the reinforcement learning is performed while a search is being conducted. The formula for updating the value Q (S, A) as described above can be represented by, for example, Expression 2 below (hereinafter represented as mathematical 2).

$$Q ( {S}_{t + 1} , {A}_{t + 1} ) ← Q ( {S}_{t} , {A}_{t} ) + α ( {r}_{t + 1} + γ {max}_{A} Q ( {S}_{t + 1} , A ) - Q ( {S}_{t} , {A}_{t} ) ) \qquad [ Math . 2 ]$$

In Expression 2 described above, Sₜ represents the state of the environment at the time t, and Aₜ represents an action at the time t. The state is changed into Sₜ₊₁ by the action Aₜ. rₜ₊₁ represents a reward which can be obtained by the change of the state. A term including max is obtained by multiplying a Q value when an action A whose Q value is the highest at that time under the state Sₜ₊₁ is selected by γ. Here, γ is a parameter of 0<γ≤1, and is called the discount rate. α is a learning coefficient and is assumed to fall within a range of 0<α≤1.

The Expression 2 described above indicates a method of updating the value Q (Sₜ, Aₜ) of the action Aₜ in the state Sₜ based on the reward rₜ₊₁ which is returned as a result of a trial Aₜ. This updating formula indicates that when the value maxₐ Q (Sₜ₊₁, A) of the best action in the subsequent state Sₜ₊₁ by the action Aₜ is higher than the value Q (Sₜ, Aₜ) of the action Aₜ in the state Sₜ, Q (Sₜ, Aₜ) is increased whereas when the value maxₐ Q (Sₜ₊₁, A) is lower than the value Q (Sₜ, Aₜ), Q (Sₜ, Aₜ) is decreased. In other words, the value of a certain action in a certain state is brought close to the value of the best action in the subsequent state resulting therefrom. Although the difference thereof is changed according to the discount rate γ and the reward rₜ₊₁, a mechanism is formed such that the value of the best action in a certain state is basically propagated to the value of the action in the preceding state.

Here, in the Q-learning, there is a method in which a table of Q (S, A) for all state action pairs (S, A) is produced and in which thus learning is performed. However, it is likely that since a large number of states are present so that the values of Q (S, A) for all state action pairs are determined, it takes much time to conclude the Q-learning.

Hence, a known technology called DQN (Deep Q-Network) may be utilized. Specifically, a value function Q is configured with an appropriate neural network, a parameter for the neural network is adjusted and thus the value function Q is approximated with the appropriate neural network, with the result that the value of the value Q (S, A) may be calculated. By the utilization of the DQN, it is possible to reduce the time necessary for the conclusion of the Q-learning. On the DQN, for example, a non-patent document below discloses the details thereof.

### Non-Patent Document

“Human-level control through deep reinforcement learning”, written by Volodymyr Mnihl [online], [search on Jan. 17, 2017], Internet <URL: http://files.davidqiu.com/research/nature14236.pdf>

The Q-learning described above is performed by the machine learning device 110. Specifically, the machine learning device 110 learns the value Q in which the values of the individual coefficients a₀, a₁ and b₁ in the transfer function of the filter 313, the input/output gain (amplitude ratio) output from the output device 210 and the phase delay are assumed to be the state S and in which the adjustment of the values of the individual coefficients a₀, a₁ and b₁ in the transfer function of the filter 313 in the state S is selected as the action A.

The machine learning device 110 uses, based on the individual coefficients a₀, a₁ and b₁ in the transfer function of the filter 313, the velocity command which is described previously and which is a sinusoidal wave whose frequency is varied so as to drive the servo control device 310, and thereby observes state information S which is obtained from the output device 210 and which includes the input/output gain (amplitude ratio) and the phase delay for each frequency so as to determine the action A. In the machine learning device 110, each time the action A is performed, a reward is returned. For example, the machine learning device 110 searches the optimum action A in a trial and error manner such that the total of rewards in the future is maximized. In this way, the machine learning device 110 uses, based on the individual coefficients a₀, a₁ and b₁ in the transfer function of the filter 313, the velocity command which is a sinusoidal wave whose frequency is varied so as to drive the servo control device 310, and thereby can select the optimum action A (that is, the optimum coefficients a₀, a₁ and b₁ in the transfer function of the filter 313) for the state S which is obtained from the output device 210 and which includes the input/output gain (amplitude ratio) and the phase delay for each frequency.

In other words, based on the value function Q learned by the machine learning device 110, among the actions A applied to the individual coefficients a₀, a₁ and b₁ in the transfer function of the filter 313 in the certain state S, such an action A as to maximize the value of Q is selected, and thus it is possible to select such an action A (that is, the individual coefficients a₀, a₁ and b₁ in the transfer function of the filter 313) as to minimize the vibration of the machine end caused by the execution of a machining program.

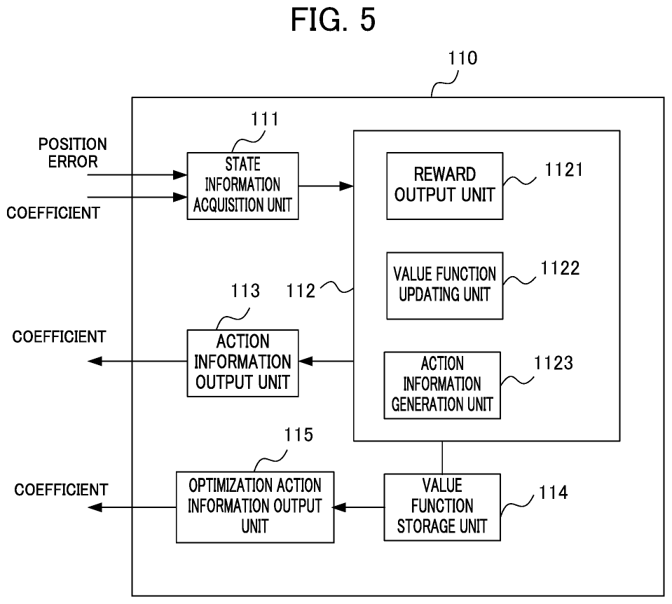

FIG. 5 is a block diagram showing the machine learning device 110 according to the first embodiment of the present invention. In order to perform the reinforcement learning described above, as shown in FIG. 5, the machine learning device 110 includes a state information acquisition unit 111, a learning unit 112, an action information output unit 113, a value function storage unit 114 and an optimization action information output unit 115. The learning unit 112 includes a reward output unit 1121, a value function updating unit 1122 and an action information generation unit 1123.

The state information acquisition unit 111 acquires, from the output device 210, the state S which is obtained by using, based on the individual coefficients a₀, a₁ and b₁ in the transfer function of the filter 313, the velocity command (sinusoidal wave) so as to drive the servo motor 410 and which includes the input/output gain (amplitude ratio) and the phase delay. The state information S corresponds to an environment state S in the Q-learning. The state information acquisition unit 111 outputs the acquired state information S to the learning unit 112.

The individual coefficients a₀, a₁ and b₁ in the transfer function of the filter 313 when the Q-learning is first started are previously generated by the user. In the present example, the initial setting values of the individual coefficients a₀, a₁ and b₁ in the transfer function of the filter 313 which are produced by the user are adjusted so as to be the optimum ones by the reinforcement learning. With respect to the coefficients a₀, a₁ and b₁, when the machine tool is previously adjusted by the operator, machine learning may be performed by using, as initial values, values which have been adjusted.

The learning unit 112 is a unit which learns the value Q (S, A) when a certain action A is selected under a certain environment state S.

The reward output unit 1121 is a unit which calculates a reward when the action A is selected under the certain state S. The reward output unit 1121 compares an input/output gain Gs which is measured when the individual coefficients a₀, a₁ and b₁ in the transfer function of the filter 313 are corrected with the input/output gain Gb of a preset reference model for each frequency. When the measured input/output gain Gs is larger than the input/output gain Gb of the reference model, the reward output unit 1121 provides a negative reward. On the other hand, when the measured input/output gain Gs is equal to or lower than the input/output gain Gb of the reference model, if the phase delay is decreased, the reward output unit 1121 provides a positive reward, if the phase delay is increased, the reward output unit 1121 provides a negative reward or if the phase delay remains the same, the reward output unit 1121 provides a zero reward.

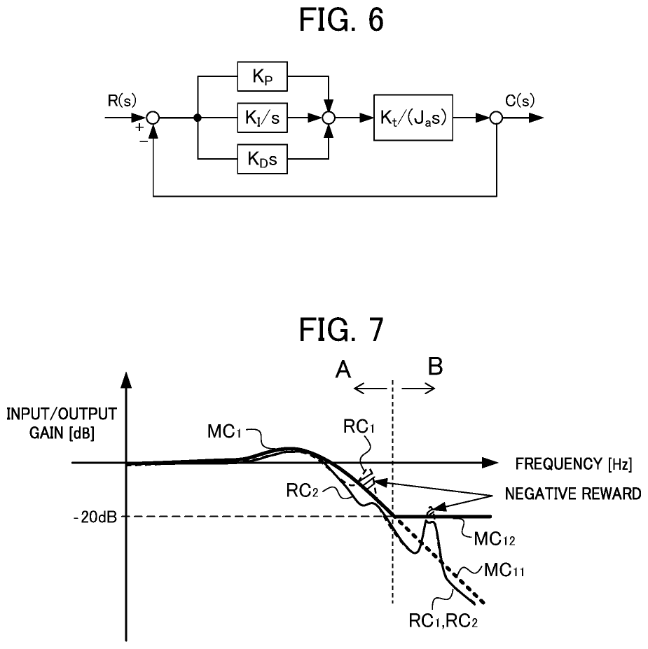

An operation in which the reward output unit 1121 provides a negative reward when the measured input/output gain Gs is larger than the input/output gain Gb of the reference model will be described with reference to FIGS. 6 and 7. The reward output unit 1121 stores the reference model of the input/output gain. The reference model is a model of the servo control device which has an ideal characteristic without resonance. The reference model can be determined by calculation from, for example, inertia Ja, a torque constant Kₜ, a proportional gain Kₚ, an integral gain K_{I} and a differential gain K_{D} of a model shown in FIG. 6. The inertia Ja is an addition value of motor inertia and machine inertia. FIG. 7 is a characteristic chart showing the frequency characteristics of the input/output gains of the servo control device of the reference model and the servo control device 310 before and after the learning. As shown in the characteristic chart of FIG. 7, the reference model includes: a region A which is a frequency region where an ideal input/output gain that is a constant input/output gain or more, for example, −20 dB or more is provided; and a region B which is a frequency region where an input/output gain less than the constant input/output gain is provided. In the region A of FIG. 7, the ideal input/output gain of the reference model is indicated by a curve MC₁ (thick line). In the region B of FIG. 7, an ideal virtual input/output gain of the reference model is indicated by a curve MC₁₁ (broken thick line) and the input/output gain of the reference model is assumed to be constant so as to be indicated by a straight line MC₁₂ (thick line). In the regions A and B of FIG. 7, the curves of the input/output gains with a servo control unit before and after the learning are indicated by curves RC₁ and RC₂, respectively.

In the region A, when the curve RC₁ of the measured input/output gain before the learning exceeds the curve MC₁ of the ideal input/output gain of the reference model, the reward output unit 1121 provides a first negative reward. In the region B which exceeds a frequency in which the input/output gain is sufficiently small, even when the curve RC₁ of the input/output gain before the learning exceeds the curve MC₁₁ of the ideal virtual input/output gain of the reference model, an influence on stability is reduced. Hence, in the region B, as described above, for the input/output gain of the reference model, instead of the curve MC₁₁ having an ideal gain characteristic, the straight line MC₁₂ having a constant input/output gain (for example, −20 dB) is used. However, when the curve RC₁ of the measured input/output gain before the learning exceeds the straight line MC₁₂ of the constant input/output gain, since instability may be caused, a first negative value is provided as the reward.

Then, an operation in which when the measured input/output gain Gs is equal to or less than the input/output gain Gb of the reference model, the reward output unit 1121 determines the reward based on the information of the phase delay will be described. In the following description, the phase delay which is a state variable related to the state information S is represented by D(S), and the phase delay which is a state variable related to a state S′ into which the state S is changed by action information A (the correction of the individual coefficients a₀, a₁ and b₁ in the transfer function of the filter 313) is represented by D(S′).

As a method in which the reward output unit 1121 determines the reward based on the information of the phase delay, for example, there is a method which will be described below. The method of determining the reward based on the information of the phase delay is not particularly limited to the method which will be described below. When the state S is changed into the state S′, the reward is determined depending on which one of the following cases applies: a case where the frequency in which the phase delay is 180 degrees is increased, a case where the frequency is decreased and a case where the frequency is the same. Although here, the case where the phase delay is 180 degrees is described, there is no particular limitation to 180 degrees, and another value may be adopted. For example, when the phase delay is shown in the phase diagram of FIG. 4 and the state S is changed into the state S′, if a curve is changed such that the frequency in which the phase delay is 180 degrees is decreased (toward the direction of X₂ in FIG. 4), the phase delay is increased. On the other hand, when the state S is changed into the state S′, if the curve is changed such that the frequency in which the phase delay is 180 degrees is increased (toward the direction of X₁ in FIG. 4), the phase delay is decreased.

Hence, when the state S is changed into the state S′, if the frequency in which the phase delay is 180 degrees is decreased, it is defined that phase delay D(S)<phase delay D(S′), and the reward output unit 1121 sets the value of the reward to a second negative value. The absolute value of the second negative value is set lower than the first negative value. On the other hand, when the state S is changed into the state S′, if the frequency in which the phase delay is 180 degrees is increased, it is defined that phase delay D(S)> phase delay D(S′), and the reward output unit 1121 sets the value of the reward to a positive value. When the state S is changed into the state S′, if the frequency in which the phase delay is 180 degrees remains the same, it is defined that phase delay D(S)=phase delay D(S′), and the reward output unit 1121 sets the value of the reward to a zero value.

A negative value when it is defined that the phase delay D(S′) in the state S′ after the action A is performed is larger than the phase delay D(S) in the preceding state S may be increased according to the ratio thereof. For example, in the method described above, the negative value is preferably increased according to the degree to which the frequency is decreased. By contrast, a positive value when it is defined that the phase delay D(S′) in the state S′ after the action A is performed is smaller than the phase delay D(S) in the preceding state S may be increased according to the ratio thereof. For example, in the first method described above, the positive value is preferably increased according to the degree to which the frequency is increased.

The value function updating unit 1122 performs the Q-learning based on the state S, the action A, the state S′ when the action A is applied to the state S and the value of a reward calculated as described above so as to update the value function Q stored in the value function storage unit 114. The updating of the value function Q may be performed by online learning, may be performed by batch learning or may be performed by mini-batch learning. The online learning is a learning method in which a certain action A is applied to the current state S, and in which thus each time the state S is changed to the new state S′, the value function Q is immediately updated. The batch learning is a learning method in which a certain action A is applied to the current state S, and in which thus the state S is repeatedly changed to the new state S′ such that data for the learning is collected and that all the data for the learning which is collected is used so as to update the value function Q. Furthermore, the mini-batch learning is an intermediate learning method between the online learning and the batch learning in which each time a certain amount of data for the learning is stored, the value function Q is updated.

The action information generation unit 1123 selects the action A in the process of the Q-learning for the current state S. The action information generation unit 1123 generates, in the process of the Q-learning, the action information A for performing an operation (which corresponds to the action A in the Q-learning) of correcting the individual coefficients a₀, a₁ and b₁ in the transfer function of the filter 313, and outputs the generated action information A to the action information output unit 113. More specifically, the action information generation unit 1123 incrementally adds or subtracts the individual coefficients a₀, a₁ and b₁ in the transfer function of the filter 313 included in the action A to or from the individual coefficients a₀, a₁ and b₁ in the transfer function of the filter 313 included in the state S.

Then, when the action information generation unit 1123 applies the increase or the decrease in the individual coefficients a₀, a₁ and b₁ in the transfer function of the filter 313, the state is changed to the state S′ and a plus reward (positive reward) is returned, the action information generation unit 1123 may select the subsequent action A′ such as for incrementally performing addition or subtraction on the individual coefficients a₀, a₁ and b₁ in the transfer function of the filter 313 in the same manner as the preceding action such that the measured phase delay is smaller than the preceding phase delay.

By contrast, when a minus reward (negative reward) is returned, the action information generation unit 1123 may select the subsequent action A′ such as for incrementally performing subtraction or addition on the individual coefficients a₀, a₁ and b₁ in the transfer function of the filter 313 in a manner opposite to the preceding action such that when the measured input/output gain is larger than the input/output gain of the reference model, the difference in the input/output gain is decreased as compared with the preceding action or the measured phase delay is smaller than the preceding phase delay.

The action information generation unit 1123 may select the action A′ by a known method such as a greedy method of selecting the action A′ whose value Q (S, A) is the highest in the value of the action A that is currently estimated or an e greedy method of randomly selecting the action A′ with a small probability a and otherwise selecting the action A′ whose value Q (S, A) is the highest.

The action information output unit 113 is a unit which transmits, to the filter 313, the action information A output from the learning unit 112. As described previously, the filter 313 slightly corrects, based on the action information, the current state S, that is, the individual coefficients a₀, a₁ and b₁ which are currently set so as to change the state to the subsequent state S′ (that is, the individual coefficients of the filter 313 which are corrected).

The value function storage unit 114 is a storage device which stores the value function Q. The value function Q may be stored, for example, for each state S or each action A, in a table (hereinafter referred to as an action value table). The value function Q stored in the value function storage unit 114 is updated with the value function updating unit 1122. The value function Q stored in the value function storage unit 114 may be shared with another machine learning device 110. When the value function Q is shared between a plurality of machine learning devices 110, the reinforcement learning can be dispersedly performed in the individual machine learning devices 110, and thus the efficiency of the reinforcement learning can be enhanced.

The optimization action information output unit 115 generates, based on the value function Q which is updated as a result of the value function updating unit 1122 performing the Q-learning, the action information A (hereinafter referred to as “optimization action information”) for making the filter 313 perform an operation of maximizing the value Q (S, A). More specifically, the optimization action information output unit 115 acquires the value function Q stored in the value function storage unit 114. As described above, this value function Q is updated as a result of the value function updating unit 1122 performing the Q-learning. Then, the optimization action information output unit 115 generates the action information based on the value function Q, and outputs the generated action information to the filter 313. In the optimization action information described above, as with the action information output by the action information output unit 113 in the process of the Q-learning, information for correcting the individual coefficients a₀, a₁ and b₁ in the transfer function of the filter 313 is included.

In the filter 313, based on this action information, the individual coefficients ac, a₁ and b₁ in the transfer function are corrected. The machine learning device 110 performs the operation described above so as to optimize the individual coefficients a₀, a₁ and b₁ in the transfer function of the filter 313, and thereby can reduce the vibration of the machine end.

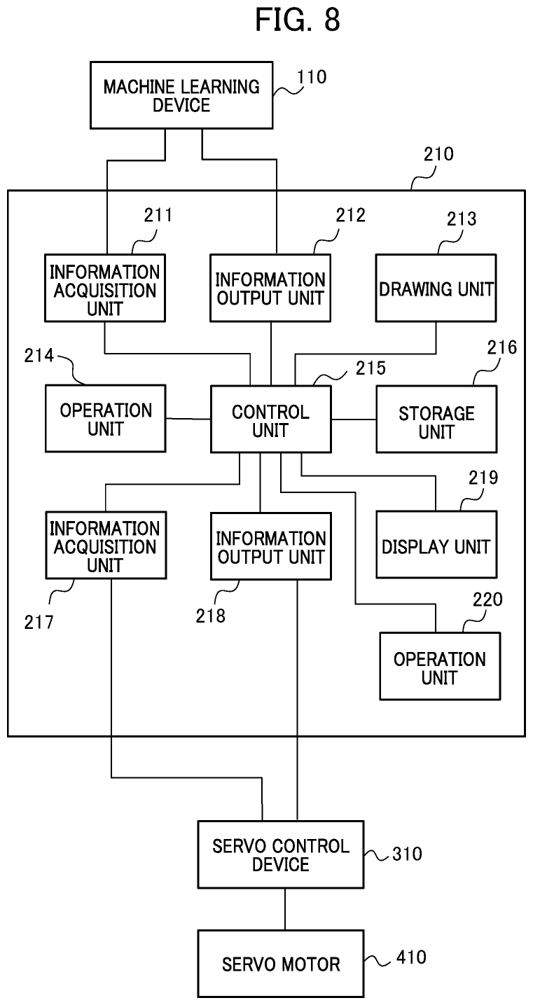

As described above, the machine learning device 110 according to the present example is utilized, and thus it is possible to simplify the parameter adjustment on the filter 313. Although in the embodiment discussed above, the case where one resonance point is present in the machine driven by the servo motor 410 is described, a plurality of resonance points may be present in the machine. When a plurality of resonance points are present in the machine, a plurality of filters are provided so as to correspond to the individual resonance points and are connected in series, and thus it is possible to attenuate all the resonance. The machine learning device sequentially determines, for the individual coefficients a₀, a₁ and b₁ in the filters, by the machine learning, optimum values for attenuating the resonance points. The output device 210 will then be described. FIG. 8 is a block diagram showing an example of the configuration of the output device included in the control device according to the first example of the present invention. As shown in FIG. 8, the output device 210 includes an information acquisition unit 211, an information output unit 212, a drawing unit 213, an operation unit 214, a control unit 215, a storage unit 216, an information acquisition unit 217, an information output unit 218, a display unit 219 and an operation unit 220. The information acquisition unit 211 serves as an information acquisition unit which acquires the learning parameters from the machine learning device 110. The control unit 215 and the display unit 219 serve as an output unit which outputs the physical quantities of the learning parameters. As the display unit 219 of the output unit, a liquid crystal display device, a printer or the like can be used. The output includes storage in the storage unit 216, and in such a case, the output unit is the control unit 215 and the storage unit 216. The output device 210 has an output function of showing, as a figure, the physical quantities of the control parameters (learning parameters) that are being machine learned or have been machine learned in the machine learning device 110 and the frequency response determined with the physical quantities such as the center frequency (which is also referred to as the attenuation center frequency), the bandwidth and the attenuation coefficient in the transfer function G(s) of the filter and the frequency response of the filter. The output device 210 also has an adjustment function which performs the relay of information (for example, the input/output gain and the phase delay) between the servo control device 310 and the machine learning device and information (for example, the information of correction of the coefficients of the filter 313) between the machine learning device 1100 and the servo control device 310, control (for example, fine adjustment of the filter 313) on the servo control device 310 and control (for example, an instruction to start up a learning program to the machine learning device) on the operation of the machine learning device 100. The relay of the information and the control on the operations are performed through the information acquisition units 211 and 217 and the information output units 212 and 218.

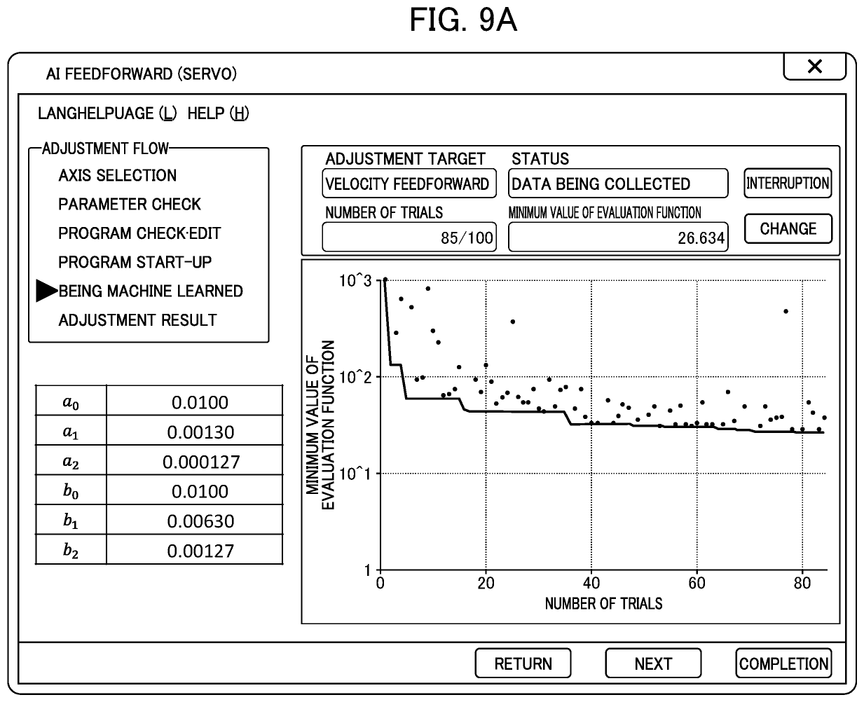

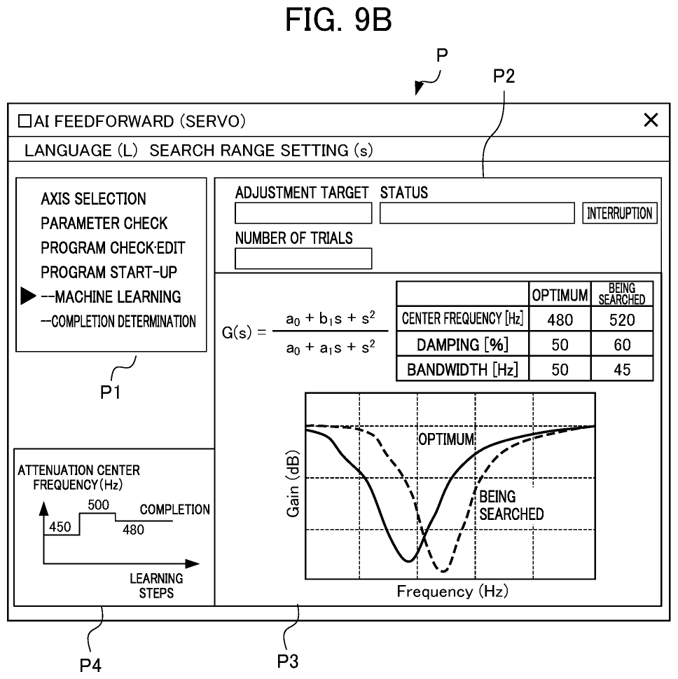

A case where the output device 210 outputs the physical quantities of the control parameters which are being machine learned will first be described with reference to FIGS. 9A and 9B. FIG. 9A is a characteristic chart showing an evaluation function value which is being machine learned and the progress of the minimum value of the evaluation function value and a diagram showing an example of the display screen when the values of the control parameters which are being learned are displayed. FIG. 9B is a diagram showing an example of the display screen when the physical quantities of the control parameters related to the state S are displayed in the display unit 219 so as to correspond to the progress of the machine learning while the machine learning is being performed. Even when as shown in FIG. 9A, the evaluation function value which is being machine learned and the minimum value of the evaluation function value and the coefficients a₀, a₁, a₂, b₀, b₁ and b₂ in the transfer function of Expression 1 are displayed on the display screen of the display unit 219, the user does not understand the physical meanings of the evaluation function and the control parameters, with the result that it is difficult to understand the learning progress and the result of the characteristics of the servo control device. Hence, in the present example, as will be described below, the control parameters are changed into information which is easily understood by the user such as the operator so as to be output. In second to fourth examples, the control parameters are likewise changed into information which is easily understood by the user such as the operator so as to be output. For example, by pressing down the button of “change” on the display screen shown in FIG. 9A, the display screen shown in FIG. 9B may be displayed such that information which is easily understood by the user is output. As shown in FIG. 9B, for example, in the column P1 of an adjustment flow on the display screen P of the display unit 219, selection items of axis selection, parameter check, program check edit, program start-up, being machine learned and completion determination are displayed. On the display screen P, a column P2 is displayed which shows, for example, an adjustment target such as the filter, a status (state) such as data being collected, the number of trials indicating the total number of trials up to the present time with respect to the preset number of trials (hereinafter also referred to as the “maximum number of trials”) up to the completion of the machine learning and a button for selecting the interruption of the learning. On the display screen P, a column P3 is displayed which includes the transfer function G(s) of the filter, a table of the center frequency fc, the bandwidth fw and the attenuation coefficient R in the transfer function G(s) of the filter and a figure showing the frequency response characteristic of the current filter and the most excellent frequency response characteristic of the filter in the learning. Furthermore, a column P4 is displayed which includes a figure showing the progress of the center frequency (attenuation center frequency) fc for learning steps. The information displayed on the display screen P is an example, and part of the information, for example, only a figure showing the frequency response characteristic of the filter and the most excellent frequency response characteristic of the filter in the learning may be displayed or another piece of information may be added.

When the user such as the operator selects, with the operation unit 214 such as a mouse or a keyboard, the “machine learning” in the column P1 of the “adjustment flow” on the display screen shown in FIG. 9B in the display unit 219 such as a liquid crystal display device, the control unit 215 feeds, through the information output unit 212, to the machine learning device 110, an instruction to output the coefficients a₀, a₁ and b₁ related to the state S associated with the number of trials, information on the adjustment target (learning target) of the machine learning, the number of trials, information including the maximum number of trials and the like.

When the information acquisition unit 211 receives, from the machine learning device 110, the coefficients a₀, a₁ and b₁ related to the state S associated with the number of trials, the information on the adjustment target (learning target) of the machine learning, the number of trials, the information including the maximum number of trials and the like, the control unit 215 stores the received information in the storage unit 216, and transfers control to the operation unit 220.

The operation unit 220 determines, from the control parameters which are being machine learned in the machine learning device 110, specifically, the control parameters (for example, the above-described coefficients a₀, a₁ and b₁ related to the state S) at the time of the reinforcement learning or after the reinforcement learning, the characteristics (the center frequency fc, the bandwidth fw and the attenuation coefficient R) of the filter 313 and the frequency response of the filter 313. The center frequency fc, the bandwidth fw and the attenuation coefficient R are second physical quantities which are determined from the coefficients a₀, a₁ and b₁. In order to determine the center frequency fc, the bandwidth fw and the attenuation coefficient (damping) R from the coefficients a₀, a₁ and b₁, a center angle frequency ωn, a fractional bandwidth ζ and the attenuation coefficient R are determined from Expression 3, and the center frequency fc and the bandwidth fw are further determined from ωn=2πfc and ζ=fw/fc.

$$\frac{{a}_{0} + {b}_{1} s + {s}^{2}}{{a}_{0} + {a}_{1} s + {s}^{2}} = \frac{{ω}_{c}^{2} + 2 δ τ {ω}_{c} s + {s}^{2}}{{ω}_{c}^{2 } + 2 τ {ω}_{c s + {s}^{2}}} \qquad [ Math . 3 ]$$

Consequently, the center frequency fc, the bandwidth fw and the attenuation coefficient R can be determined by Expression 4.

$${f}_{c} = \frac{\sqrt{{a}_{0}}}{2 π} , {f}_{w} = \frac{{a}_{1}}{2 π} , δ = \frac{{b}_{1}}{{a}_{1}} \qquad [ Math . 4 ]$$

The center frequency fc, the bandwidth fw and the attenuation coefficient R may be calculated, by use of ωn=2πfc and ζ=fw/fc, from the center angle frequency ωn, the fractional bandwidth ζ and the attenuation coefficient R which are determined by assuming that the transfer function in the right side of Expression 3 is the transfer function of the filter 313 and machine learning the parameters of the center angle frequency ωn, the fractional bandwidth ζ and the attenuation coefficient R in the machine learning device 110. In this case, the center frequency fc, the bandwidth fw and the attenuation coefficient R are first physical quantities. The first physical quantities may be changed into the second physical quantities, and thus they may be displayed. When the operation unit 220 calculates the center frequency fc, the bandwidth fw and the attenuation coefficient R, and the transfer function including the center angle frequency ωn, the fractional bandwidth ζ and the attenuation coefficient R in the right side of Expression 3 is determined, control is transferred to the control unit 215. Although here, a case where the filter is the notch filter is described, even when the filter is in the form of a general formula as indicated in Expression 1, since the filter has the valley of a gain, the center frequency fc, the bandwidth fw and the attenuation coefficient R can be determined. In general, no matter how high the order of the filter is, it is likewise possible to determine one or more of the center frequency fc, the bandwidth fw and the attenuation coefficient R which are attenuated.

The control unit 215 stores, in the storage unit 216, the physical quantities of the center frequency fc, the bandwidth fw and the attenuation coefficient R and the transfer function including the center angle frequency ωn, the fractional bandwidth ζ and the attenuation coefficient R, and transfers processing to the drawing unit 213. The drawing unit 213 determines the frequency response of the filter 313 from the transfer function including the coefficients a₀, a₁ and b₁ related to the state S associated with the number of trials, the transfer function including the center angle frequency ωn, the fractional bandwidth ζ and the attenuation coefficient R (which are the first physical quantities) or the transfer function including the center angle frequency ωn, the fractional bandwidth ζ and the attenuation coefficient R (which are the second physical quantities) determined from the coefficients a₀, a₁ and b₁, produces a frequency-gain characteristic chart, performs processing for adding the most excellent frequency response characteristic of the filter during the learning to the frequency-gain characteristic chart, produces image information of the frequency-gain characteristic chart to which the most excellent frequency response characteristic of the filter is added, further produces a drawing showing the progress of the center frequency (attenuation center frequency) fc for the learning steps, produces image information of the drawing and transfers control to the control unit 215. The frequency response of the filter 313 can be determined from the transfer function in the right side of Expression 3. Software which can analyze the frequency response from the transfer function is known, and, for example, the followings can be used:

https://jp.mathworks.com/help/signal/ug/frequency˜renponse.html
https://jp.mathworks.com/help/signal/ref/freqz.html;
https://docs.scipy.org/doc/scipy-0.19.1/reference/generated/scipy.signal.freqz.html;
https://wiki.octave.org/Control_package; and the like.

The control unit 215 displays, as shown in FIG. 9B, the frequency-gain characteristic chart (which indicates the frequency response characteristic), the table formed with the center frequency fc, the bandwidth fw and the attenuation coefficient (damping) R (which are the second physical quantities) and the figure showing the progress of the transfer function G(s) of the filter and the center frequency (attenuation center frequency) fc for the learning steps. Although here, both the center frequency fc, the bandwidth fw and the attenuation coefficient (damping) R which are the second physical quantities and the frequency-gain characteristic chart which indicates the frequency response characteristic are shown, any one of them may be displayed. Instead of the frequency-gain characteristic chart indicating the frequency response characteristic or together with the frequency-gain characteristic chart indicating the frequency response characteristic, a time-gain characteristic chart indicating a time response characteristic may be displayed. This point is the same as in second to fourth examples which will be described later. The control unit 215 displays “notch filter” in the adjustment target item of the column P2 on the display screen P shown in FIG. 9B, for example, based on information indicating that the notch filter is the adjustment target, and when the number of trials does not reach the maximum number of trials, “data being collected” is displayed in the status item of the display screen. The control unit 215 further displays, in the item of the number of trials on the display screen, a ratio of the number of trials to the maximum number of trials.

The display screen shown in FIG. 9B is an example, and the present invention is not limited to this display screen. Information other than the items illustrated above may be displayed. The display of information of some items illustrated above may be omitted. Although in the above description, the control unit 215 stores information received from the machine learning device 110 in the storage unit 216, and displays, in real time, in the display unit 219, for example, information on the frequency response of the filter 313 related to the state S associated with the number of trials, there is no limitation to this configuration. Examples where a display is not produced in real time include the followings. Variation 1: When the operator provides a display instruction, the information shown in FIG. 9B is displayed. Variation 2: When the total number of trials (after the start of the learning) reaches a preset number of trials, the information shown in FIG. 9B is displayed. Variation 3: When the machine learning is interrupted or completed, the information shown in FIG. 9B is displayed.

Even in variations 1 to 3 described above, as in the operation of the real-time display described above, when the information acquisition unit 211 receives, from the machine learning device 110, the coefficients a₀, a₁ and b₁ related to the state S associated with the number of trials, the information on the adjustment target (learning target) of the machine learning, the number of trials and the information including the maximum number of trials and the like, the control unit 215 stores the received information in the storage unit 216. Thereafter, the control unit 215 transfers control to the operation unit 220 and the drawing unit 213 when in variation 1, the operator provides a display instruction, when in variation 2, the total number of trials reaches a preset number of trials or when in variation 3, the machine learning is interrupted or completed.

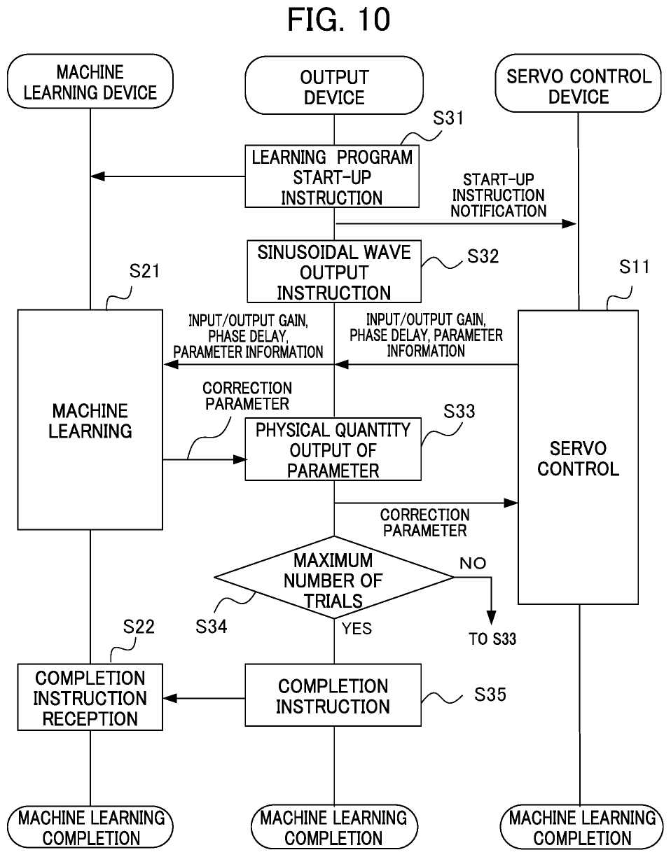

The output function and the adjustment function of the output device 210 will then be described. FIG. 10 is a flowchart showing the operation of the control device after the start of the machine learning until the completion of the machine learning while focusing attention on the output device. In step S31, in the output device 210, when the operator selects, with the operation unit 214 such as a mouse or a keyboard, the “program start-up” in the column P1 of the “adjustment flow” on the display screen of the display unit 219 shown in FIG. 9, the control unit 215 outputs an instruction to start up the learning program through the information output unit 212 to the machine learning device 110. Then, the output device 210 outputs, to the servo control device 310, a learning program start-up instruction notification which notifies the output of the learning program start-up instruction to the machine learning device 110. In step S32, the output device 210 provides a sinusoidal wave output instruction to a high-level device which outputs a sinusoidal wave to the servo control device 310. Step S32 may be performed before step S31 or simultaneously with step S31. When the high-level device receives the sinusoidal wave output instruction, the high-level device outputs a sinusoidal signal whose frequency is changed to the servo control device 310. In step S21, when the machine learning device 110 receives the learning program start-up instruction, the machine learning device 110 starts the machine learning.

In step S11, the servo control device 310 controls the servo motor 410 so as to output, to the output device 210, parameter information, the input/output gain and the phase delay and information including the coefficients a₀, a₁ and b₁ in the transfer function of the filter 313 (serving as the parameter information). Then, the output device 210 outputs, to the machine learning device 110, the parameter information, the input/output gain and the phase delay.

The machine learning device 110 outputs, to the output device 210, information including the coefficients a₀, a₁ and b₁ in the transfer function of the filter 313 related to the state S associated with the number of trials used in a reward output unit 2021 while the machine learning operation is being performed in step S21, the maximum number of trials, the number of trials and the correction information (serving as parameter correction information) of the coefficients a₀, a₁ and b₁ in the transfer function of the filter 313. In step S33, when the “machine learning” in the column P1 of the “adjustment flow” on the display screen shown in FIG. 9B is selected, the output device 210 uses the output function described above to change the correction information of the coefficients in the transfer function of the filter 313 which are being machine learned in the machine learning device 110 into a diagram showing the progress of the physical quantities (the center frequency fc, the bandwidth fw and the attenuation coefficient R) which are easily understood by the user such as the operator and the center frequency (attenuation center frequency) fc with respect to the learning steps and a frequency response characteristic chart, and outputs them to the display unit 219. In step S33 or after or before step S33, the output device 210 feeds the coefficients in the transfer function of the filter 313 to the servo control device 310. Step S11, step S21 and step S33 are repeatedly performed until the completion of the machine learning.

Although here, the case is described where the physical quantities (the center frequency fc, the bandwidth fw and the attenuation coefficient R) of the coefficients in the transfer function of the filter 313 related to the control parameters which are being machine learned and information related to the frequency response characteristic chart are output in real time to the display unit 219, in the cases of variations 1 to 3 which have already been described as examples of the case where a display is not produced in real time, the physical quantities of the coefficients in the transfer function of the filter 313 and the information related to the frequency response characteristic chart may be output in real time to the display unit 219.

In step S34, the output device 210 determines whether or not the number of trials reaches the maximum number of trials, and when the maximum number of trials is reached, in step S35, the output device 210 feeds a completion instruction to the machine learning device 210. When the maximum number of trials is not reached, the process returns to step S33. When in step S35, the machine learning device 210 receives the completion instruction, the machine learning device 210 completes the machine learning. The first example of the output device and the control device in the first embodiment has been described above, and the second example will then be described.

### Second Example

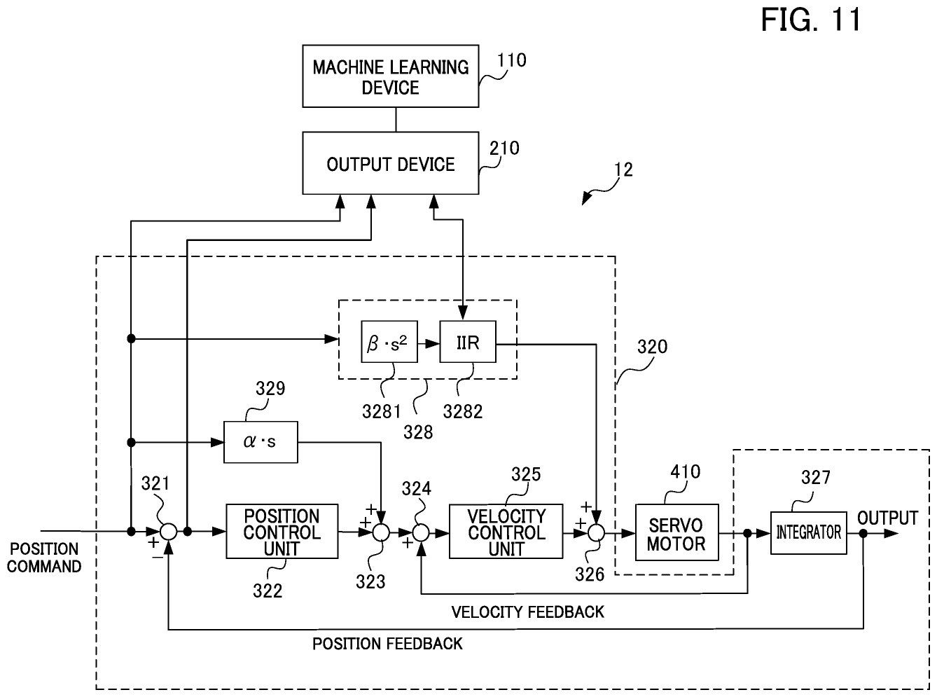

The present example is an example where the machine learning device 110 learns the coefficients of a velocity feedforward processing unit included in a servo control device 320 and where the output device 210 displays, in the display unit, the progress of the frequency response and the position error of the velocity feedforward processing unit. FIG. 11 is a block diagram showing the entire configuration of a control device and the configuration of the servo control device according to the second example of the present invention. The control device of the present example differs from the control device shown in FIG. 1 in the configuration of the servo control device and the operation of the machine learning device and the output device. The configurations of the machine learning device and the output device in the present example are the same as those of the machine learning device and the output device in the first example described with reference to FIGS. 5 and 8.

As shown in FIG. 11, the servo control device 320 includes, as constituent elements, a subtractor 321, a position control unit 322, an adder 323, a subtractor 324, a velocity control unit 325, an adder 326, an integrator 327, the velocity feedforward processing unit 328 and a position feed forward processing unit 329. The adder 326 is connected to the servo motor 410 through a current control unit which is not shown. The velocity feedforward processing unit 328 includes a double differentiator 3281 and an IIR filter 3282. Although here, the position feedforward processing unit 329 does not include the IIR filter, the IIR filter is provided, the coefficients of the IIR filter are learned as in the velocity feedforward processing unit, and as will be described later, the output device 210 may be used to output information of the frequency response of the IIR filter, the time response of a position error, a frequency response and the like. In other words, the output device 210 may be used to output information of the frequency response of one or both of the velocity feedforward processing unit 328 and the position feedforward processing unit 329, the time response of the position error, the frequency response and the like.

A position command is output to the subtractor 321, the velocity feedforward processing unit 328, the position feedforward processing unit 329 and the output device 210. The subtractor 321 determines a difference between a position command value and a detection position subjected to position feedback, and outputs the difference as the position error to the position control unit 322 and the output device 210.

The position command is produced by the high-level device based on a program for operating the servo motor 410. The servo motor 410 is included in a machine tool, for example. In a machine tool, when a table having a workpiece (a work) mounted thereon moves in an X-axis direction and a Y-axis direction, the servo control device 320 and the servo motor 410 illustrated in FIG. 11 are provided in the X-axis direction and the Y-axis direction, respectively. When the table is moved in the directions of three or more axes, the servo control device 320 and the servo motor 410 are provided in the respective axis directions. In the position command, a feed velocity is set such that a machined shape specified by the machining program is provided.

The position control unit 322 outputs a value obtained by multiplying a position gain Kp by the position error to the adder 323 as a velocity command value.

The adder 323 adds the velocity command value and the output value (the position feedforward term) of the position feedforward processing unit 329 and outputs an addition result to the subtractor 324 as a feedforward-controlled velocity command value. The subtractor 324 calculates a difference between the output of the adder 323 and a feedback velocity detection value and outputs the difference to the velocity control unit 325 as a velocity error.

The velocity control unit 325 adds a value obtained by multiplying and integrating an integral gain K1v by the velocity error and a value obtained by multiplying a proportional gain K2v by the velocity error and outputs an addition result to the adder 326 as a torque command value.

The adder 326 adds the torque command value and an output value (the velocity feedforward term) of the velocity feedforward processing unit 328 and outputs the addition result to the servo motor 410 as a feedforward-controlled torque command value via not shown current control unit to drive the servo motor 410.

A rotational angular position of the servo motor 410 is detected by a rotary encoder serving as a position detection unit associated with the servo motor 410, and a velocity detection value is input to the subtractor 324 as a velocity feedback. The velocity detection value is integrated by the integrator 327 to be a position detection value, and the position detection value is input to the subtractor 102 as a position feedback.

The double differentiator 3281 of the velocity feedforward processing unit 328 differentiates the position command value two times and multiplies a differentiation result by a constant β, and the IIR filter 3282 performs IIR filter process represented by a transfer function VFF(z) in Expression 5 (indicated by Math. 1 below) on the output of the double differentiator 3281 and outputs the processing result to the adder 326 as a velocity feedforward term. Coefficients c₁, c₂, d₀ to d₂ in Expression 5 are coefficients of the transfer function of the IIR filter 3282. Although the denominator and the numerator of the transfer function VFF(z) are quadratic functions in this example, the denominator and the numerator are not particularly limited to a quadratic function but may be a cubic function or a higher-order function.

$$VFF ( z ) = \frac{{b}_{0} + {b}_{1} {z}^{- 1} + {b}_{2} {z}^{- 2}}{1 + {a}_{1} {z}^{- 1} + {a}_{2} {z}^{- 2}} \qquad [ Math . 5 ]$$

The position feedforward processing unit 329 differentiates the position command value and multiplies a differentiation result by a constant α, and outputs the processing result to the adder 323 as a position feedforward term. The servo control device 320 is configured in this manner.

The machine learning device 110 executes the preset machining program (hereinafter also referred to as a “learning machining program”) so as to learn the coefficients in the transfer function of the IIR filter 3282 of the velocity feedforward processing unit 328. Here, a machining shape designated by the learning machining program is an octagon or a shape in which the corners of an octagon are alternately replaced with arcs. Here, the machining shape designated by the learning machining program is not limited to these machining shapes but may be other machining shapes.

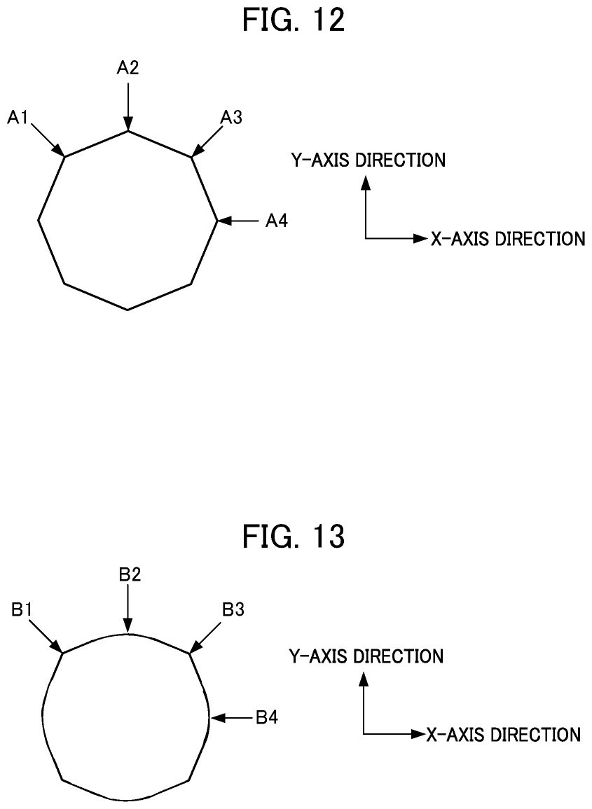

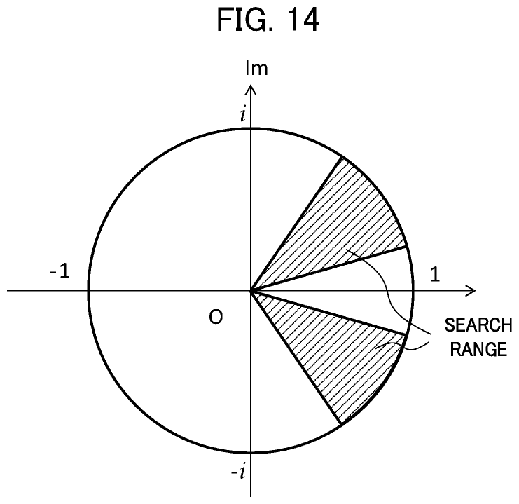

FIG. 12 is a diagram for describing an operation of a motor when a machining shape is an octagon. FIG. 13 is a diagram for describing an operation of a motor when a machining shape is a shape in which the corners of an octagon are alternately replaced with arcs. In FIGS. 12 and 13, it is assumed that a table is moved in the X and Y-axis directions so that a workpiece (a work) is machined in the clockwise direction.

When the machining shape is an octagon, as illustrated in FIG. 12, the rotation velocity of a motor that moves the table in the Y-axis direction decreases at the corner position A1 whereas the rotation velocity of a motor that moves the table in the X-axis direction increases. In the position A2 of a corner, the rotation direction of the motor which moves the table in Y-axis direction is reversed, and the motor that moves the table in the X-axis direction rotates at an equal velocity in the same rotation direction from the position A1 to the position A2 and from the position A2 to the position A3. The rotation velocity of the motor that moves the table in the Y-axis direction increases at the corner position A3 whereas the rotation velocity of a motor that moves the table in the X-axis direction decreases. In the position A4 of a corner, the rotation direction of the motor which moves the table in the X-axis direction is reversed, and the motor that moves the table in the Y-axis direction rotates at an equal velocity in the same rotation direction from the position A3 to the position A4 and from the position A4 to the next corner position.

When the machining shape is a shape in which the corners of an octagon are alternately replaced with arcs, as illustrated in FIG. 13, the rotation velocity of a motor that moves the table in the Y-axis direction decreases at the corner position B1 whereas the rotation velocity of a motor that moves the table in the X-axis direction increases. In the position B2 of an arc, the direction of rotation of the motor which moves the table in Y-axis direction is reversed, and the motor which moves the table in the X-axis direction is rotated from the position B1 to the position B3 in the same rotation direction and at constant velocity. Unlike the case in which the machining shape is an octagon illustrated in FIG. 12, the rotation velocity of the motor that moves the table in the Y-axis direction decreases gradually as it approaches the position B2, the rotation stops at the position B2, and the rotation velocity increases gradually as it departs from the position B2 so that a machining shape of an arc is formed before and after the position B2.

The rotation velocity of the motor that moves the table in the Y-axis direction increases at the corner position B3 whereas the rotation velocity of a motor that moves the table in the X-axis direction decreases. A rotation direction of the motor that moves the table in the X-axis direction is reversed at the arc position B4, and the table moves to be linearly reversed in the X-axis direction. Moreover, the motor that moves the table in the Y-axis direction rotates at an equal velocity in the same rotation direction from the position B3 to the position B4 and from the position B4 to the next corner position. The rotation velocity of the motor that moves the table in the X-axis direction decreases gradually as it approaches the position B4, the rotation stops at the position B4, and the rotation velocity increases gradually as it departs from the position B4 so that a machining shape of an arc is formed before and after the position B4.

In the present embodiment, as described above, vibration is evaluated when the rotation velocity is changed between the position A1 and the position A3 and between the position B1 and the position B3 in the linear control of the machined shape specified by the learning machining program, an influence on the position error is checked and thus the machine learning on the optimization of the coefficients in the transfer function of the IIR filter 3282 of the velocity feedforward processing unit 328 is performed. The machine learning on the optimization of the coefficients in the transfer function of the IIR filter is not particularly limited to the velocity feedforward processing unit, and can also be applied to, for example, the position feedforward processing unit which includes the IIR filter or to a current feedforward processing unit which is provided when current feedforward on the servo control device is performed and which includes the IIR filter.

Hereinafter, the machine learning device 110 will be described in further detail. An example of the machine learning will be described on the assumption that the machine learning device 110 of the present embodiment performs the reinforcement learning on the optimization of the coefficients in the transfer function of the IIR filter 3282 of the velocity feedforward processing unit 328. Moreover, machine learning in the present invention is not limited to reinforcement learning but the present invention can be also applied to a case of performing another machine learning (for example, supervised learning).

The machine learning device 110 machine learns a value Q of selecting an action A of adjusting the coefficients a₁, a₂, and b₀ to b₂ of the transfer function VFF(z) of the IIR filter 3282 associated with a state S wherein the state S is a servo state such as commands and feedbacks including the coefficients a₁, a₂, and b₀ to b₂ of the transfer function VFF(z) of the IIR filter 3282 of the velocity feedforward processing unit 328, and the position error information and the position command of the servo control device 320 acquired by executing the machine learning machining program. (hereinafter referred to as learning). Specifically, the machine learning device 100 according to the embodiment of the present invention sets the coefficients of the transfer function VFF(z) of the IIR filter 3282 by searching for, within a predetermined range, a radius r and an angle θ which represent a zero-point and a pole of the transfer function VFF(z) in polar coordinates, respectively, to learn the radius r and the angle θ. The pole is the value of z at which the transfer function VFF(z) is infinity and the zero-point is the value of z at which the transfer function VFF(z) is 0. Due to this, the coefficients in the numerator of the transfer function VFF(z) re modified as follows.

b₀+b₁z⁻¹+b₂z⁻²=b₀(1+(b₁/b₀)z⁻¹+(b₂/b₀)z⁻²)

Hereinafter, (b₁/b₀) and (b₂/b₀) will be denoted by b₁′ and b₂′, respectively, unless particularly stated otherwise. The machine learning device 110 learns the radius r and the angle θ which minimize the position error to set the coefficients a₁, a₂, b₁′, and b₂′ of the transfer function VFF(z). The coefficient b₀ may be obtained by performing machine learning after the radius r and the angle θ are set to optimal values r₀ and θ₀, for example. The coefficient b₀ may be learned simultaneously with the angle θ. Moreover, the coefficient b₀ may be learned simultaneously with the radius r.

The machine learning device 110 observes the state information S including the servo state such as commands and feedbacks including the position commands and the position error information of the servo control device 320 at the positions A1 and A3 and/or the positions B1 and B3 of the machining shape by executing the learning machining program on the basis of the values of the coefficients a₁, a₂, and b₀ to b₂ of the transfer function VFF(z) of the IIR filter 3282 to determine the action A. The machine learning device 110 receives a reward whenever the action A is executed. The machine learning device 110 searches in trial-and-error manner for the optimal action A so that the total of the reward over the course of the future is maximized. By doing so, the machine learning device 110 can select an optimal action A (that is, the values of the optimal zero-point and pole of the transfer function VFF(z) of the IIR filter 3282) with respect to the state S including the servo state such as commands and feedbacks including the position commands and the position error information of the servo control device 320 acquired by executing the learning machining program on the basis of the values of the coefficients calculated on the basis of the values of the zero-point and the pole of the transfer function VFF(z) of the IIR filter 3282. The rotation direction of the servo motor in the X-axis direction and the Y-axis direction does not change at the positions A1 and A3 and the positions B1 and B3, and hence, the machine learning device 110 can learn the values of the zero-point and the pole of the transfer function VFF(z) of the IIR filter 3282 during linear operation.

That is, it is possible to select an action A (that is, the values of the zero-point and the pole of the transfer function VFF(z) of the IIR filter 3282) that minimizes the position error, which is acquired by executing the learning machining program, by selecting an action A that maximizes the value of Q from among the actions A applied to the transfer function VFF(z) of the IIR filter 3282 associated with a certain state S on the basis of the value function Q learned by the machine learning device 110.

Hereinafter, a method of learning the radius r and the angle θ representing the zero-point and the pole of the transfer function VFF(z) of the IIR filter 3282, which minimize the position error, in polar coordinates, to obtain the coefficients a₁, a₂, b₁′, and b₂′ of the transfer function VFF(z) and a method of obtaining the coefficient b₀ will be described.

The machine learning device 110 sets a pole which is z at which the transfer function VFF(z) in Expression 5 is infinity and a zero-point which is z at which the transfer function VFF(z) is 0, acquired from the IIR filter 3282. The machine learning device 110 multiplies the denominator and the numerator in Expression 5 by z² to obtain Expression 6 (indicated by Math. 6 below) in order to obtain the pole and the zero-point.

$$VFF ( z ) = \frac{{b}_{0} ( {z}^{2} + {b}_{1}^{′} z + {b}_{2}^{′} )}{{z}^{2} + {a}_{1} z + {a}_{2}} \qquad [ Math . 6 ]$$

The pole is z at which the denominator of Expression 6 is 0 (that is, z²+a₁z+a₂=0), and the zero-point is z at which the numerator of Expression 6 is 0 (that is, z²+b₁′z+b₂′=0).

In the present embodiment, the pole and the zero-point are represented in polar coordinates and searches for the pole and the zero-point represented in polar coordinates. The zero-point is important in suppressing vibration, and the machine learning device 110, first, fixes the pole and sets the coefficients b₁′ (=−re^{iθ}−re^{-iθ}) and b₂′ (=r²) calculated when z=re^{iθ} and the conjugate complex number z*=re^{-iθ} in the numerator (z²+b₁′z+b_{2′}) are the zero-point (the angle θ is in a predetermined range, and 0≤r≤1) as the coefficients of the transfer function VFF(z) to search for the zero-point re^{iθ} in polar coordinates to learn the values of the optimal coefficients b₁′ and b₂′. The radius r depends on an attenuation factor, and the angle θ depends on a vibration suppression frequency. After that, the zero-point may be fixed to an optimal value and the value of the coefficient b₀ may be learned. Subsequently, the pole of the transfer function VFF(z) is represented in polar coordinates, and the value re^{iθ} of the pole represented in polar coordinates is searched for by a method similar to the method used for the zero-point. By doing so, it is possible to learn the values of the optimal coefficients a₁ and a₂ in the denominator of the transfer function VFF(z). When the pole is fixed and the coefficients in the numerator of the transfer function VFF(z), it is sufficient to be able to suppress a high-frequency-side gain, and for example, the pole corresponds to a 2nd-order low-pass filter. For example, a transfer function of a 2nd-order low-pass filter is represented by Expression 7 (indicated as Math. 7 below).

ω is a peak gain frequency of the filter.

$$\frac{1}{{s}^{2} + \sqrt{2} ω s + {ω}^{2}} \qquad [ Math . 7 ]$$

When the pole is a 3rd-order low-pass filter, the 3rd-order low-pass filter can be formed by providing three 1st-order low-pass filters of which the transfer function is represented by 1/(1+Ts) (T is a time constant of the filter) and may be formed by combining the 1st-order low-pass filter with the 2nd-order low-pass filter in Expression 5. The transfer function in the z-domain is obtained using bilinear transformation of the transfer function in the s-domain.

Although the pole and the zero-point of the transfer function VFF(z) can be searched simultaneously, it is possible to reduce the amount of machine learning and shorten the learning time when the pole and the zero-point are searched and learned separately.

The search ranges of the pole and the zero-point can be narrowed down to predetermined search ranges indicated by hatched regions by defining the radius r in the range of 0≤r≤1, for example, in a complex plane in FIG. 14 and defining the angle θ in a responsible frequency range of a velocity loop. The upper limit of the frequency range can be set to 110 Hz since the vibration generated due to resonance of the velocity loop is approximately 110 Hz, for example. Although the search range is determined by resonance characteristics of a control target such as a machine tool, since the angle θ corresponds to 90° at approximately 250 Hz when the sampling period is 1 msec, if the upper limit of the frequency range is 110 Hz, a search range of the angle θ is obtained as in the complex plane of FIG. 14. By narrowing down the search range to a predetermined range in this manner, it is possible to reduce the amount of machine learning and shorten the settling time of machine learning.

When the zero-point is searched for in polar coordinates, first, the coefficient b₀ is fixed to 1, for example, and the radius r is fixed to an arbitrary value within the range of 0≤r≤1, and the angle θ in the search range illustrated in FIG. 14 is set in a trial-and-error manner to thereby set the coefficients b₁′ (=−re^{jθ}−re^{-jθ}) and b₂′ (=r²) such that z and the conjugate complex number z* are the zero-point of (z²+b₁′z+b₂′). The initial setting value of the angle θ is set in the search range illustrated in FIG. 14. The machine learning device 110 transmits the adjustment information of the obtained coefficients b₁′ and b₂′ to the IIR filter 3282 as the action A and sets the coefficients b₁′ and b₂′ in the numerator of the transfer function VFF(z) of the IIR filter 3282. The coefficient b₀ is set to 1, for example, as described above. When such an ideal angle θ₀ that maximizes the value of the value function Q by the machine learning device 110 performing learning to search for the angle θ is determined, the angle θ is fixed to the angle θ₀ and the radius r is varied to thereby set the coefficients b₁′ (=−re^{jθ}−re^{-jθ}) and b₂′ (=r²) in the numerator of the transfer function VFF(z) of the IIR filter 3282. By the learning of searching for the radius r, such an optimal radius r₀ that maximizes the value of the value function Q is determined. The coefficients b₁′ and b₂′ are set with the aid of the angle θ₀ and the radius r₀, and after that, learning is performed with respect to b₀, whereby the coefficients b₀, b₁′, and b₂′ in the numerator of the transfer function VFF(z) are determined.

When the pole is searched for in polar coordinates, learning can be performed similarly to the denominator of the transfer function VFF(z). First, the radius r is fixed to a value in the range of (for example, 0≤r≤1), and the angle θ is searched for in the search range similarly to the searching of the zero-point to determine an ideal angle θ of the pole of the transfer function VFF(z) of the IIR filter 3282 by learning. After that, the angle θ is fixed to the angle and the radius r is searched for and learned whereby the ideal angle θ and the ideal radius r of the pole of the transfer function VFF(z) of the IIR filter 3282 are determined. By doing so, the optimal coefficients a₁ and a₂ corresponding to the ideal angle θ and the ideal radius r of the pole are determined. As described above, the radius r depends on the attenuation factor, and the angle θ depends on a vibration suppression frequency. Therefore, it is preferable to learn the angle θ prior to the radius r in order to suppress vibration.

In this manner, by searching for, within a predetermined range, the radius r and the angle θ which represent the zero-point and the pole of the transfer function VFF(z) of the IIR filter 3282 in polar coordinates, respectively, so that the position error is minimized, it is possible to perform optimization of the coefficients a₁, a₂, b₀, b₁′, and b₂′ of the transfer function VFF(z) more efficiently than learning the coefficients a₁, a₂, b₀, b₁′, and b₂′ directly.

When the coefficient b₀ of the transfer function VFF(z) of the IIR filter 3282 is learned, the initial value of the coefficient b₀ is set to 1, for example, and after that, the coefficient b₀ of the transfer function VFF(z) included in the action A is increased or decreased incrementally. The initial value of the coefficient b₀ is not limited to 1. The initial value of the coefficient b₀ may be set to an arbitrary value. The machine learning device 110 returns a reward on the basis of a position error whenever the action A is executed and adjusts the coefficient b₀ of the transfer function VFF(z) to an ideal value that maximizes the value of the value function Q by reinforcement learning of searching for the optimal action A in a trial-and-error manner so that a total future reward is maximized. Although the learning of the coefficient b₀ is performed subsequently to the learning of the radius r in this example, the coefficient b₀ may be learned simultaneously with the angle θ and may be learned simultaneously with the radius r. Although the radius r, the angle θ, and the coefficient b₀ can be learned simultaneously, it is possible to reduce the amount of machine learning and shorten the settling time of machine learning when these coefficients are learned separately.

The configuration of the machine learning device 110 in FIG. 11 is the same as the configuration shown in FIG. 5, and thus a description will be given below with reference to FIG. 5. The state information acquisition unit 111 acquires, from the servo control device 320, the state S including a servo state such as commands and feedbacks including the position commands and the position error information of the servo control device 132 acquired by executing the learning machining program on the basis of the values of the coefficients a₁, a₂, and b₀ to b₂ of the transfer function VFF(z) of the IIR filter 3282 of the velocity feedforward processing unit 328 of the servo control device 320. The state information S corresponds to a state S of the environment in the Q-learning. The state information acquisition unit 111 outputs the acquired state information S to the learning unit 112. Moreover, the state information acquisition unit 111 acquires the angle θ and the radius r which represent the zero-point and the pole in polar coordinates and the corresponding coefficients a₁, a₂, b₁′, and b₂′ from the action information generation unit 1123 to store the same therein and outputs the angle θ and the radius r which represent the zero-point and the pole corresponding to the coefficients a₁, a₂, b₁′, and b₂′ acquired from the servo control device 320 in polar coordinates to the learning unit 112.

The initial setting values of the transfer function VFF(z) of the IIR filter 3282 at a time point at which the Q-learning starts initially are set by a user in advance. In the present embodiment, after that, the initial setting values of the coefficients a₁, a₂, and b₀ to b₂ of the transfer function VFF(z) of the IIR filter 3282 set by the user are adjusted to optimal values by reinforcement learning of searching for the radius r and the angle θ which represent the zero-point and the pole in polar coordinates as described above. The coefficient α of the double differentiator 3281 of the velocity feedforward processing unit 328 is set to a fixed value such as α=1, for example. Moreover, the initial setting values in the denominator of the transfer function VFF(z) of the IIR filter 3282 are set to those illustrated in Math. 5 (the transfer function in the z-domain converted by bilinear transformation). Moreover, as for the initial setting values of the coefficients b₀ to b₂ in the numerator of the transfer function VFF(z), b₀=1, the radius r can be set to a value within the range of 0≤r≤1, and the angle θ can be set to a value within the predetermined search range. Furthermore, as for the coefficients a₁, a₂, and b₀ to b₂ and the coefficients c₁, c₂, and d₀ to d₂, when an operator adjusts the machine tool in advance, machine learning may be performed using the values of the radius r and the angle θ which represent the zero-point and the pole of the adjusted transfer function in polar coordinates as initial values.

The learning unit 112 is a unit that learns the value Q (S, A) when a certain action A is selected under a certain state S of the environment. Here, the action A fixes the coefficient b₀ to 1, for example, and calculates the correction information of the coefficients b₁′ and b₂′ in the numerator of the transfer function VFF(z) of the IIR filter 3282 on the basis of the correction information of the radius r and the angle θ which represent the zero-point of the transfer function VFF(z) in polar coordinates. In the following description, a case in which the coefficient b₀ is initially set as 1, for example, and the action information A is the correction information of the coefficients b₁′ and b₂′ will be described as an example.

The reward output unit 1121 is a unit that calculates a reward when the action A is selected under a certain state S. Here, a set (a position error set) of position errors which are state variables of the state S will be denoted by PD(S), and a position error set which is state variables related to state information S′ which is changed from the state S due to the action information A will be denoted by PD(S′). Moreover, the position error value in the state S is a value calculated based on a predetermined evaluation function f(PD(S)).

Functions can be used as the evaluation function f includes:

A function that calculates an integrated value of an absolute value of a position error
∫|e|dt

A function that calculates an integrated value by a weighting an absolute value of a position error with time

∫t|e|dt

A function that calculates an integrated value of a 2n-th power (n is a natural number) of an absolute value of a position error

∫e²ⁿdt (n is a natural number)

A function that calculates a maximum value of an absolute value of a position error Max {|e|}.

In this case, the reward output unit 1121 sets the value of a reward to a negative value when the position error value f(PD(S′)) of the servo control device 320 operated based on the velocity feedforward processing unit 328 after the correction related to the state information S′ corrected by the action information A is larger than the position error value f(PD(S)) of the servo control device 320 operated based on the velocity feedforward processing unit 328 before correction related to the state information S before being corrected by the action information A.

On the other hand, the reward output unit 1121 sets the value of the reward to a positive value when the position error value f(PD(S′)) of the servo control device 320 operated based on the velocity feedforward processing unit 328 after the correction related to the state information S′ corrected by the action information A is smaller than the position error value f(PD(S)) of the servo control device 320 operated based on the velocity feedforward processing unit 328 before correction related to the state information S before being corrected by the action information A. Moreover, the reward output unit 1121 may set the value of the reward to zero when the position error value f(PD(S′)) of the servo control device 320 operated based on the velocity feedforward processing unit 328 after the correction related to the state information S′ corrected by the action information A is equal to the position error value f(PD(S)) of the servo control device 320 operated based on the velocity feedforward processing unit 328 before correction related to the state information S before being corrected by the action information A.

Furthermore, if the position error value f(PD(S′)) in the state S′ after execution of the action A becomes larger than the position error value f(PD(S)) in the previous state S, the negative value may be increased according to the proportion. That is, the negative value may be increased according to the degree of increase in the position error value. In contrast, if the position error value f(PD(S′)) in the state S′ after execution of the action A becomes smaller than the position error value f(PD(S)) in the previous state S, the positive value may be increased according to the proportion. That is, the positive value may be increased according to the degree of decrease in the position error value.

The value function updating unit 1122 updates the value function Q stored in the value function storage unit 114 by performing Q-learning based on the state S, the action A, the state S′ when the action A was applied to the state S, and the value of the reward calculated in the above-mentioned manner. The updating of the value function Q may be performed by online learning, batch learning, or mini-batch learning.

The action information generation unit 1123 selects the action A in the process of Q-learning with respect to the present state S. The action information generation unit 1123 generates action information A and outputs the generated action information A to the action information output unit 113 in order to perform an operation (corresponding to the action A of Q-learning) of correcting the coefficients b₁′ and b₂′ of the transfer function VFF(z) of the IIR filter 3282 of the servo control device 320 in the process of Q-learning on the basis of the radius r and the angle θ which represent the zero-point in polar coordinates. More specifically, the action information generation unit 1123 increases or decreases the angle θ received from the state information acquisition unit 111 within the search range illustrated in FIG. 14 in a state in which the coefficients a₁, a₂, and b₀ of the transfer function VFF(z) in Expression 6 are fixed and the radius r received from the state information acquisition unit 111 while setting the zero-point of z in the numerator (z²+b₁′z+b₂′) as re^{iθ} in order to search for the zero-point in polar coordinates, for example. Moreover, z serving as the zero-point and the conjugate complex number thereof z* are set with the aid of the fixed radius z and the increased or decreased angle θ, and new coefficients b₁′ and b₂′ are calculated on the basis of the zero-point.

When the state S transitions to the state S′ by increasing or decreasing the angle θ and newly setting the coefficients b₁′ and b₂′ of the transfer function VFF(z) of the IIR filter 3282, and a plus reward (a positive reward) is offered in return, the action information generation unit 1123 may select a policy where an action A′ that leads to the value of the position error becoming further decreased, such as by increasing or decreasing the angle θ similarly to the previous action, is selected as the next action A′.

In contrast, when a minus reward (a negative reward) is offered in return, the action information generation unit 1123 may select a policy where an action A′ that leads to the value of the position error becoming smaller than the previous value, such as by decreasing or increasing the angle θ contrarily to the previous action, is selected as the next action A′.

When searching of the angle θ is continued and an ideal angle θ₀ that maximizes the value of the value Q is determined by learning with the aid of optimization action information (to be described later) from the optimization action information output unit 115, the action information generation unit 1123 fixes the angle θ to the angle θ₀ to search for the radius r within the range of 0≤r≤1 and sets the coefficients b₁′ and b₂′ in the numerator of the transfer function VFF(z) of the IIR filter 3282 similarly to the searching of the angle θ. When searching of the radius r is continued and an ideal radius r₀ that maximizes the value of the value Q is determined by learning with the aid of the optimization action information (to be described later) from the optimization action information output unit 115, the action information generation unit 1123 determines the optimal coefficients b₁′ and b₂′ in the numerator. After that, as described above, the optimal values of the coefficients in the numerator of the transfer function VFF(z) are learned by learning the coefficient b₀.

After that, the action information generation unit 1123 searches for the coefficients of the transfer function related to the numerator of the transfer function VFF(z) on the basis of the radius r and the angle θ which represent the pole in polar coordinates as described above. The learning adjusts the radius r and the angle θ which represent the pole in polar coordinates by reinforcement learning similarly to the case in the numerator of the transfer function VFF(z) of the IIR filter 3282. In this case, the radius r is learned after learning the angle θ similarly to the case in the numerator of the transfer function VFF(z). Since a learning method is similar to the case of searching of the zero-point of the transfer function VFF(z), the detailed description thereof will be omitted.

The action information output unit 113 is a unit that transmits the action information A output from the learning unit 112 to the servo control device 320. As described above, the servo control device 320 finely corrects the present state S (that is, the presently set radius r and angle θ which represent the zero-point of the transfer function VFF(z) of the IIR filter 3282 in polar coordinates) on the basis of the action information to thereby transition to the next state S′ (that is, the coefficients b₁′ and b₂′ of the transfer function VFF(z) of the IIR filter 3282 corresponding to the corrected zero-point).

The value function storage unit 114 is a storage device that stores the value function Q. The value function Q may be stored as a table (hereinafter referred to as an action value table) for each sate S and each action A, for example. The value function Q stored in the value function storage unit 114 is updated by the value function updating unit 1122. Moreover, the value function Q stored in the value function storage unit 114 may be shared with other machine learning devices 110. When the value function Q is shared by a plurality of machine learning devices 110, since reinforcement learning can be performed in distributed manner in the respective machine learning devices 110, it is possible to improve the reinforcement learning efficiency.

The optimization action information output unit 115 generates the action information A (hereinafter referred to as “optimization action information”) which causes the velocity feedforward processing unit 328 to perform an operation of maximizing the value Q (S, A) based on the value function Q updated by the value function updating unit 1122 performing the Q-learning. More specifically, the optimization action information output unit 115 acquires the value function Q stored in the value function storage unit 114. As described above, the value function Q is updated by the value function updating unit 1122 performing the Q-learning. The optimization action information output unit 115 generates the action information on the basis of the value function Q and outputs the generated action information to the servo control device 320 (the IIR filter 3282 of the velocity feedforward processing unit 328). The optimization action information includes information that corrects the coefficients of the transfer function VFF(z) of the IIR filter 3282 by learning the angle θ, the radius r, and the coefficient b₀ similarly to the action information that the action information output unit 113 outputs in the process of Q-learning.

In the servo control device 320, the coefficients of the transfer function related to the numerator of the transfer function VFF(z) of the IIR filter 3282 are corrected on the basis of the action information which is based on the angle θ, the radius r, and the coefficient b₀. After optimization of the coefficients in the numerator of the transfer function VFF(z) of the IIR filter 3282 is performed with the above-described operations, the machine learning device 110 performs optimization of the coefficients in the denominator of the transfer function VFF(z) of the IIR filter 3282 by learning the angle θ and the radius r similarly to the optimization. As described above, by using the machine learning device 110 according to the present invention, it is possible to simplify the adjustment of the parameters in the velocity feedforward processing unit 328 of the servo control device 320.

In the present embodiment, the reward output unit 1121 calculated the reward value by comparing the evaluation function value f(PD(S)) of the position error in the state S calculated on the basis of the predetermined evaluation function f(PD(S)) using the position error PD(S) in the state S as an input with the evaluation function value f(PD(S′)) of the position error in the state S′ calculated on the basis of the evaluation function f(PD(S′)) using the position error PD(S′) in the state S′ as an input. However, the reward output unit 1121 may add another element other than the position error when calculating the reward value. For example, the machine learning device 110 may add at least one of a position-feedforward-controlled velocity command output from the adder 323, a difference between a velocity feedback and a position-feedforward-controlled velocity command, and a position-feedforward-controlled torque command output from the adder 326 in addition to the position error output from the subtractor 102.

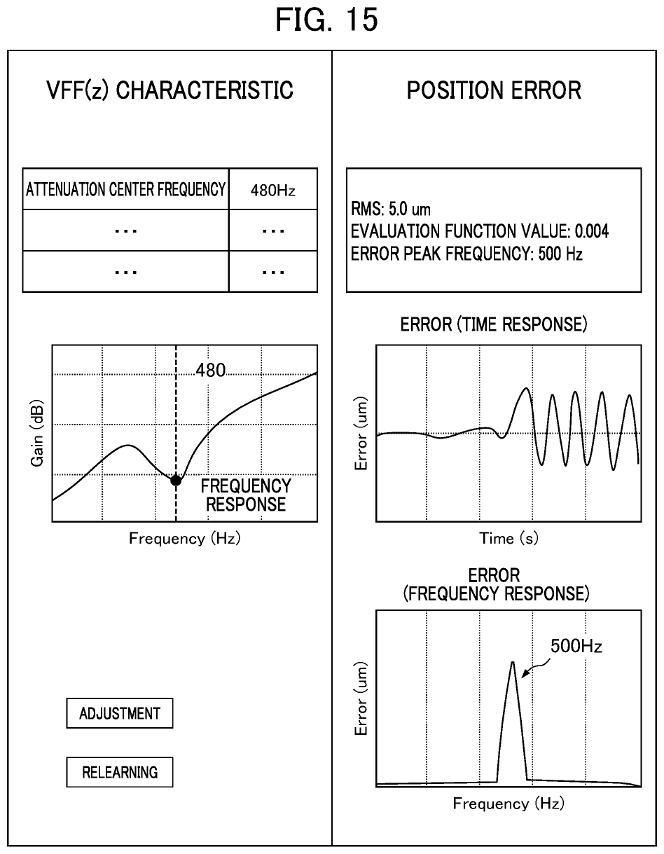

Although the output device 210 will then be described, since the configuration thereof is the same as that of the output device 210 of the first example shown in FIG. 8, only a difference in the operation will be described. The display screen of the display unit 219 in the first example is the same as the display screen of FIG. 9B shown in the first example except that the details (such as the frequency response characteristic chart of the filter) of the column P3 on the display screen P of FIG. 9B shown in the first example are replaced with the frequency response characteristic chart of a velocity feedforward processing unit shown in FIG. 15 and a diagram showing the characteristic of the position error.

In the present example, the output device 210 outputs, to the machine learning device 110, the servo state of commands, feedback and the like including the coefficients a₁, a₂ and b₀ to b₂ in the transfer function VFF(z) of the IIR filter 3282 of the velocity feedforward processing unit 328 and the position error of the servo control device 320 and the position command. Here, the control unit 215 stores, in the storage unit 216, the position error output from the subtractor 321 together with time information.

When the operator selects, with the operation unit 214 such as a mouse or a keyboard, the “machine learning” in the column P1 of the “adjustment flow” on the display screen shown in FIG. 9B in the display unit 219, the control unit 215 feeds, through the information output unit 212, to the machine learning device 110, an instruction to output the coefficients a₀, a₁ and b₀ to b₂ related to the state S associated with the number of trials, information on the adjustment target (learning target) of the machine learning, the number of trials, information including the maximum number of trials, the evaluation function value and the like.

When the information acquisition unit 211 receives, from the machine learning device 110, the coefficients a₀, a₁ and b₀ to b₂ related to the state S associated with the number of trials, the information on the adjustment target (learning target) of the machine learning, the number of trials, the maximum number of trials, information including the evaluation function value and the like, the control unit 215 stores the received information in the storage unit 216, and transfers control to the operation unit 220.

The operation unit 220 determines, from the control parameters which are being machine learned in the machine learning device 110, specifically, the control parameters (for example, the above-described coefficients a₁, a₂ and b₀ to b₂ in the transfer function VFF(z) of Expression 6 related to the state S) at the time of the reinforcement learning or after the reinforcement learning, the characteristics (the center frequency fc, the bandwidth fw and the attenuation coefficient R) of the IIR filter 3282 of the velocity feedforward processing unit 328. It is possible to determine the center frequency fc, the bandwidth fw and the attenuation coefficient (damping) R from the zero point and the pole of the transfer function VFF(z), and when the operation unit 220 calculates the center frequency fc, the bandwidth fw and the attenuation coefficient R so as to determine the transfer function VFF(z) including the center frequency fc, the bandwidth fw and the attenuation coefficient R, the operation unit 220 transfers control to the control unit 215.

The control unit 215 stores, in the storage unit 216, parameters of the center frequency fc, the bandwidth fw and the attenuation coefficient R and the transfer function VFF(z) including the center angle frequency ωn, the fractional bandwidth ζ and the attenuation coefficient R, and transfers processing to the drawing unit 213.

As described in the first example, the drawing unit 213 determines the frequency response of the IIR filter 3282 from the transfer function including the center angle frequency ωn, the fractional bandwidth ζ and the attenuation coefficient R so as to produce the frequency-gain characteristic chart. As the method of determining the frequency response of the IIR filter 3282 from the transfer function, the same method as in the first example can be used. Then, the drawing unit 213 uses the individual values of the center frequency fc, the bandwidth fw and the attenuation coefficient (damping) R so as to form a table, and combines it with the frequency-gain characteristic chart. This results in information on the VFF(z) of FIG. 15. The drawing unit 213 determines, based on the position error and the position command stored in the storage unit 216, the frequency characteristic of the position error so as to produce a frequency-position error characteristic chart. The drawing unit 213 also produces, based on the position error and the time information thereof, a time response characteristic chart of the position error. Then, the root mean square (RMS) of a position error value per sampling time, an error peak frequency which is a frequency peak when the position error is seen in a frequency region and the evaluation function are combined with the frequency-position error characteristic chart and the time response characteristic chart of the position error. This results in information on the position error of FIG. 15. The root mean square (RMS) of the position error value per sampling time and the error peak frequency may be determined with the operation unit 220. The drawing unit 213 produces image information in which the information on the VFF(z) and the information on the position error are combined, and transfers control to the control unit 215.

The control unit 215 displays, in the column P3 of FIG. 9B, the information on the VFF(z) and the information on the position error in FIG. 15. The control unit 215 displays velocity feedforward processing unit in the adjustment target item on the display screen as shown in FIG. 9B, for example, based on information indicating that the velocity feedforward processing unit is the adjustment target, and when the number of trials does not reach the maximum number of trials, data being collected is displayed in the status column on the display screen. The control unit 215 further displays, in the column of the number of trials on the display screen, a ratio of the number of trials to the maximum number of trials.

Even when the machine learning device 110 performs the learning on the coefficients a₁, a₂ and b₀ to b₂, and the evaluation function value is not changed, for example, even in a state where the machine tool is stopped after machining processing, the time response of the position error or the frequency response may be changed by vibration after the stop. The output device 210 provides, after the learning, an instruction to adjust the coefficients in the velocity feedforward processing unit or an instruction to perform relearning to the machine learning device 110 through an instruction from the operator who sees the display screen of the display unit in FIG. 15 and observes a variation in the time response of the position error or in the frequency response.

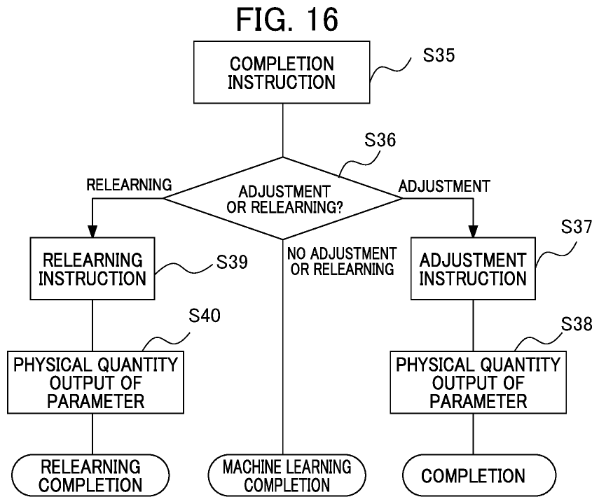

FIG. 16 is a flowchart showing the operation of the output device after an instruction to complete the machine learning in the second example of the present invention. A flow in the present example showing the operation of the control device after the start of the machine learning until the instruction to complete the machine learning while focusing attention on the output device is the same as the flow shown in FIG. 10 from step S31 to step S35 except that the state information is not the coefficients of the input/output gain, the phase delay and the notch filter but the coefficients of the position command, the position error and the velocity feedforward processing unit and that the action information is the correction information of coefficients in the velocity feedforward processing unit.

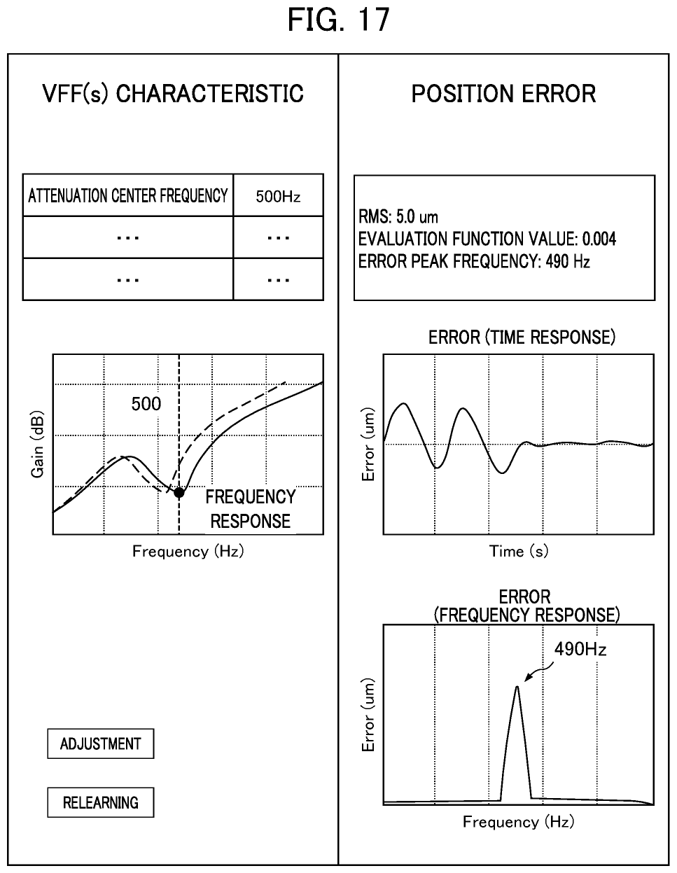

The time response characteristic chart of the position error and the frequency-position error characteristic chart in FIG. 15 show a case where the position error is increased by vibration after the stop. In FIG. 15, when the operator selects the button of “adjustment”, the individual values of the center frequency fc, the bandwidth fw and the attenuation coefficient (damping) R in the table can be changed. When the operator sees the time response characteristic chart of the position error and the frequency-position error characteristic chart in FIG. 15, the operator changes the center frequency fc in the table from 480 Hz to 500 Hz. Then, in step S36 of FIG. 16, the control unit 215 determines that the instruction is the adjustment, and in step S37, the control unit 215 outputs, to the servo control device 310, a correction instruction including correction parameters (change values of the coefficients a₁, a₂ and b₀ to b₂) of the IIR filter 3282. The servo control device 310 returns to step S11, drives the machine tool with the changed coefficients a₁, a₂ and b₀ to b₂ and outputs the position error to the output device 210. In step S38, as shown in FIG. 17, the output device 210 determines, based on the changed center frequency fc, the frequency response of the IIR filter 3282, displays the frequency-gain characteristic chart on the display screen of the display unit 219 and displays the time response characteristic chart and the frequency-position error characteristic chart showing the time response characteristic of the position error and the frequency-position error characteristic on the display screen of the display unit 219.

In this way, the operator observes the frequency response of the IIR filter 3282, the time response of the position error and the frequency response, changes, as necessary, one or a plurality of the center frequency fc, the bandwidth fw and the attenuation coefficient (damping) R and thereby can finely adjust the frequency response characteristic of the IIR filter 3282, the time response characteristic of the position error and the frequency response characteristic.

On the other hand, when the operator selects the button of “relearning” shown in FIG. 15, in step S36 of FIG. 16, the control unit 215 determines that the instruction is the relearning so as to instruct, in step S39, the machine learning device 110 to perform relearning around 480 Hz. The machine learning device 110 returns to step S21 so as to perform the relearning around 480 Hz. Here, the search range shown in FIG. 14 is changed to a range around 480 Hz or is selected from a wide range to a narrow range. In step S40, as shown in FIG. 17, the output device 210 determines the frequency response of the IIR filter 3282 based on the control parameters fed from the machine learning device, displays the frequency-gain characteristic chart on the display screen of the display unit 219 and displays the time response characteristic chart and the frequency-position error characteristic chart showing the time response characteristic of the position error and the frequency-position error characteristic on the display screen of the display unit 219.

In this way, the operator observes the frequency response of the IIR filter 3282, the time response of the position error and the frequency response so as to perform the relearning with the machine learning device 110 and thereby can perform the relearning for adjusting the frequency response characteristic of the IIR filter 3282, the time response characteristic of the position error and the frequency response characteristic. The second example of the output device the control device in the first embodiment has been described above, and a third example will then be described.

### Third Example

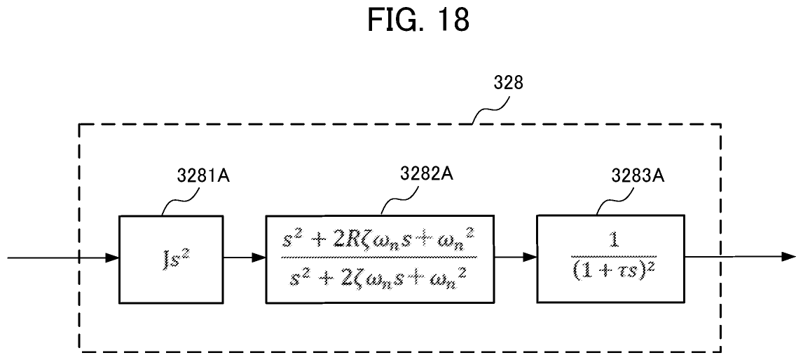

In the present example, the coefficients in the velocity feedforward processing unit of the control device in the second example are converted into values which can be understood by the user and which have physical meanings, specifically, coefficients in a motor reverse characteristic, a notch filter and a low-pass filter shown in FIG. 18 and serving as a Expression model, and specifically, inertia J, a center angle frequency (notch frequency) ωn, a fractional bandwidth (notch attenuation), an attenuation coefficient (notch depth) R and a time constant τ, and they are output. The configuration of an output device in the present example is the same as that of the output device 210 shown in FIG. 8. Although in the second example, the learning is performed with the polar coordinates, in the present example, the learning is performed without use of the polar coordinates as in the first example.

The transfer function F(s) of the velocity feedforward processing unit 328 can be represented by Expression 8 with a motor reverse characteristic 3281A, a notch filter 3282A and a low-pass filter 3283A serving as a mathematical formula model.

$$F ( s ) = \frac{{\sum }_{j = 0}^{4} {b}_{j} {s}^{j}}{{\sum }_{i = 0}^{4} {a}_{i} {s}^{i}} = \frac{{Js}^{2}}{{( 1 + τ s )}^{2}} \frac{{s}^{2} + 2 R ζ {ω}_{n} s + {ω}_{n}^{2}}{{s}^{2} + 2 ζ {ω}_{n} s + {ω}_{n}^{2}} \qquad [ Math . 8 ]$$

It holds true from Expression 8 that b₄=J, b₃=2JRζωₙ, b₁=0, b₀=0, a₄=τ², a₃=(2ζωₙτ²+2), a₂=(ωₙ²τ²+4ζωₙτ+1), a₁=(2 ζωₙ²+2ζωₙ) and a₀=ωₙ². Here, the attenuation center frequency ωₙ is represented by a formula below.

$${ω}_{n} = \sqrt{\frac{{b}_{2}}{{b}_{4}}} = \sqrt{{a}_{0}} \qquad [ Math . 9 ]$$

The fractional bandwidth (notch attenuation), the attenuation coefficient (notch depth) R and the time constant τ are calculated in the same manner.

In this way, the output device 210 determines, from the coefficients in the transfer function F(s), physical quantities which are easily understood by the user such as the operator, for example, the fractional bandwidth (notch attenuation), the attenuation coefficient (notch depth) R and the time constant τ, and can display them on the display screen of the display unit 219. A frequency response characteristic is determined from the fractional bandwidth (notch attenuation), the attenuation coefficient (notch depth) R and the time constant τ, and can be displayed on the display screen. The third example of the output device and the control device in the first embodiment has been described above, and a fourth example will then be described.

### Fourth Example

Although in the first to third examples, the case where the transfer function of the constituent elements of the servo control device is characterized as indicated by Expressions 1, 5 and 8 is described, the present embodiment can also be applied to a case where the transfer function of the constituent elements of the servo control device is a transfer function of a general formula represented by Expression 10 (n is a natural number). The constituent element of the servo control device is, for example, a velocity feedforward processing unit, a position feedforward processing unit or a current feedforward processing unit. For example, the machine learning device 110 determines the optimum coefficients aᵢ and bⱼ by machine learning such that the position error is reduced.

$$F ( s ) = \frac{{\sum }_{j = 0}^{n} {b}_{j} {s}^{j}}{{\sum }_{i = 0}^{n} {a}_{i} {s}^{i}} \qquad [ Math . 10 ]$$

Then, based on the determined coefficients aᵢ and bⱼ or a transfer function F(s) including the determined coefficients aᵢ and bⱼ, the physical quantities which are easily understood by the user and information indicating a time response or a frequency response can be output with the output device 210. When the frequency response is determined, known software which can analyze a frequency response from a transfer function is used, and thus the frequency response of the transfer function F(s) including the determined coefficients aᵢ and bⱼ is determined, and the output device 210 can display a frequency response characteristic on the display screen of the display unit 219. As the software which can analyze a frequency response from a transfer function, for example, the following software described in the first example can be used:

https://jp.mathworks.com/help/signal/ug/frequency˜renponse.html;
https://jp.mathworks.com/help/signal/ref/freqz.html;
https://docs.scipy.org/doc/scipy-0.19.1/reference/generated/scipy.signal.freqz.html; and
https://wiki.octave.org/Control_package.

The first to fourth examples of the output device and the control device in the first embodiment of the present invention have been described above, and a second embodiment and a third embodiment will then be described.

### Second Embodiment

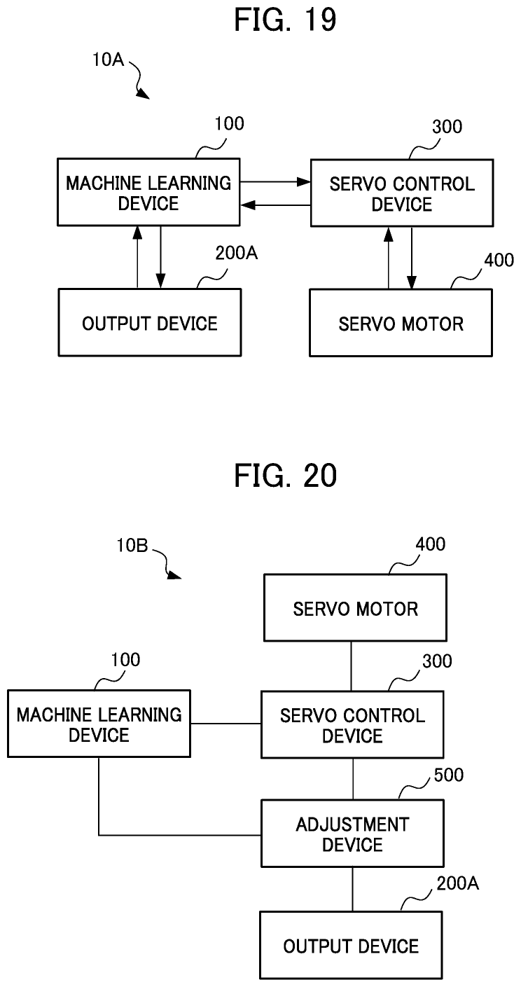

In the first embodiment, the output device 200 is connected to the servo control device 300 and the machine learning device 100, and performs the relay of information between the machine learning device 100 and the servo control device 300 and the control of the operations of the servo control device 300 and the machine learning device 100. In the present embodiment, a case where the output device is connected to only the machine learning device will be described. FIG. 19 is a block diagram showing an example of the configuration of a control device according to the second embodiment of the present invention. The control device 10A includes the machine learning device 100, an output device 200A, the servo control device 300 and the servo motor 400. As compared with the output device 200 shown in FIG. 8, the output device 200A does not include the information acquisition unit 217 and the information output unit 218.

Since the output device 200A is not connected to the servo control device 300, the output device 200A does not performs the relay of information between the machine learning device 100 and the servo control device 300 and the transmission and reception of information with the servo control device 300. Specifically, the output device 200A performs the learning program start-up instruction in step S31 and the physical quantity output of parameters in step S33 and the relearning instruction in step S35 shown in FIG. 10 but does not perform the other operations (for example, steps S32 and S34) shown in FIG. 10. In this way, since the output device 200A is not connected to the servo control device 300, the operation of the output device 200A is reduced, and thus the configuration of the device can be simplified.

### Third Embodiment

Although in the first embodiment, the output device 200 is connected to the servo control device 300 and the machine learning device 100, in the present embodiment, a case where an adjustment device is connected to the machine learning device 100 and the servo control device 300 and where the output device is connected to the adjustment device will be described. FIG. 20 is a block diagram showing an example of the configuration of a control device according to the third embodiment of the present invention. The control device 10B includes the machine learning device 100, an output device 200A, the servo control device 300 and the adjustment device 500. Although the output device 200A shown in FIG. 20 has the same configuration as the output device 200A shown in FIG. 19, the information acquisition unit 211 and the information output unit 212 are connected not to the machine learning device 100 but to the adjustment device 700. The adjustment device 500 is configured such that the drawing unit 213, the operation unit 214, the display unit 219 and the operation unit 220 in the output device 200 of FIG. 8 are omitted.

Although the output device 200A shown in FIG. 20 performs, as with the output device 200A of the second embodiment shown in FIG. 19, not only the learning program start-up instruction in step S31, the physical quantity output of parameters in step S33 and the fine adjustment instruction of parameters in step S34 shown in FIG. 10 but also the relearning instruction in step S35, these operations are performed through the adjustment device 700. The adjustment device 500 performs the relay of information between the machine learning device 100 and the servo control device 300. The adjustment device 500 relays the learning program start-up instruction and the like on the machine learning device 100 performed by the output device 200A, and outputs the start-up instructions to the machine learning device 100. In this way, as compared with the first embodiment, the function of the output device 200 is separated to the output device 200A and the adjustment device 500, and thus the operation of the output device 200A is reduced, with the result that the configuration of the device can be simplified.

Although the embodiments and examples according to the present invention have been described above, servo control unit of the servo control device described above, the components included in the machine learning device and the output device may be realized by hardware, software or a combination thereof. The servo control method performed by cooperation of the components included in the servo control device described above also may be realized by hardware, software, or a combination thereof. Here, being realized by software means being realized when a computer reads and executes a program.

The programs can be stored with various types of non-transitory computer readable storage media and can be supplied to a computer. The non-transitory computer readable media include various types of tangible storage media. Examples of the non-transitory computer readable media include a magnetic recording medium (for example a flexible disk, and a hard disk drive), a magneto-optical recording medium (for example a magneto-optical disk), a CD-ROM (Read Only Memory), a CD-R, a CD-R/W, a semiconductor memory (for example a mask ROM, a PROM (Programmable ROM), an EPROM (Erasable PROM), a flash ROM, and a RAM (Random Access Memory)).

The above-described embodiment and example are a preferred embodiment and example of the present invention. However, the scope of the present invention is not limited to the embodiment and example only but the present invention can be embodied in various modifications without departing from the spirit of the present invention. For example, although FIG. 9B shows the frequency response of the notch filter, and FIGS. 15 and 16 show the frequency response characteristics of the frequency response of the IIR filter and the like, the time response of the notch filter and the time response characteristics of the time response of the IIR filter and the like may be shown. Examples of the time response include a step response when a step-shaped input is given, an impulse response when an impulse-shaped input is given and a ramp response when an input is changed from a state where it is not changed to a state where it is changed at a constant rate. The step response, the impulse response and the ramp response can be determined from the transfer function including the center angle frequency ωn, the fractional bandwidth (and the attenuation coefficient R.

<Variations where Output Device is Included in Servo Control Device or Machine Learning Device>

In the embodiments discussed above, the example where the machine learning device 100, the output device 200 or 200A and the servo control device 300 are formed as the control device and furthermore, the example where the output device 200 is separated to the output device 200A and the adjustment device 500 and is provided in the control device are described. Although in these examples, the machine learning device 100, the output device 200 or 200A, the servo control device 300 and the adjustment device 500 are formed with separate devices, one of these devices may be integrally formed with another device. For example, part or the whole of the function of the output device 200 or 200A may be realized with the machine learning device 100 or the servo control device 300. The output device 200 or 200A may be provided outside the control device formed with the machine learning device 100 and the servo control device 3.

### <Freedom in System Configuration>

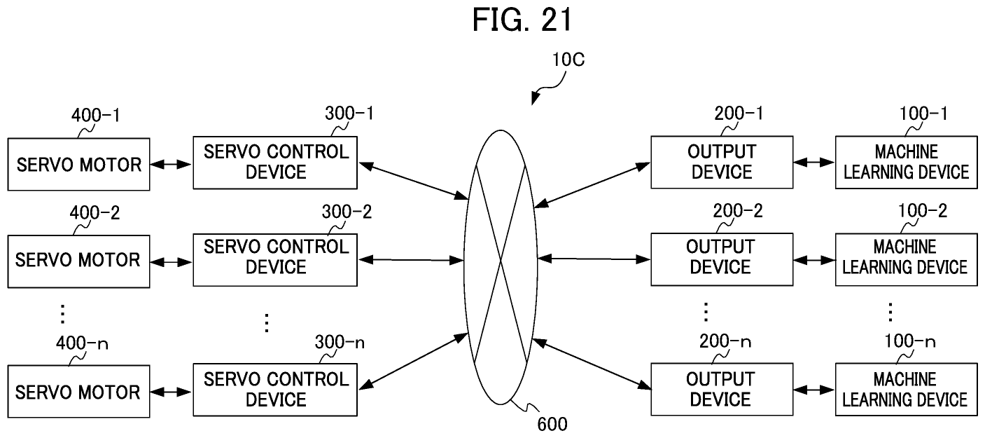

FIG. 21 is a block diagram illustrating a control device according to another embodiment of the present invention. As shown in FIG. 21, the control device 10C includes n machine learning devices 100-1 to 100-n, output devices 200-1 to 200-n, n servo control devices 300-1 to 300-n, servo motors 400-1 to 400-n and a network 600. n is a freely selected natural number. Each of the n machine learning devices 100-1 to 100-n corresponds to the machine learning device 100 illustrated in FIG. 5. The output devices 200-1 to 200-n correspond to the output device 210 shown in FIG. 8 or 200A shown in FIG. 19. Each of the n servo control devices 300-1 to 300-n corresponds to the servo control device 300 shown in FIG. 2 or FIG. 11. The output device 200A and the adjustment device 500 shown in FIG. 20 correspond to the output devices 200-1 to 200-n.

Here, the output device 200-1 and the servo control device 300-1 are formed as a one-to-one pair, and are connected so as to be able to communicate with each other. The output devices 200-2 to 200-n and the servo control devices 300-2 to 300-n are also connected as with the output device 200-1 and the servo control device 300-1. Although in FIG. 21, n pairs of the output devices 200-1 to 200-n and the servo control devices 300-1 to 300-n are connected through the network 600, in the n pairs of the output devices 200-1 to 200-n and the servo control devices 300-1 to 300-n, the output device and the servo control device in each of the pairs may be directly connected through a connection interface. In the n pairs of the output devices 200-1 to 200-n and the servo control devices 300-1 to 300-n, for example, a plurality of pairs may be installed in the same factory or they may be respectively installed in different factories.

The network 600 is, for example, a LAN (Local Area Network) established within a factory, the Internet, a public telephone network or a combination thereof. A specific communication method in the network 600, whether or not wired connection or wireless connection is used and the like are not particularly limited.

Although in the control device of FIG. 21 described above, the output devices 200-1 to 200-n and the servo control devices 300-1 to 300-n are connected as one-to-one pairs so as to be able to communicate with each other, for example, a configuration may be adopted in which one output device 200-1 is connected to a plurality of servo control devices 300-1 to 300-m (m<n or m=n) through the network 600 so as to be able to communicate with each other, and in which one machine learning device connected to the one output device 200-1 performs the machine learning on the individual servo control devices 300-1 to 300-m. In this case, a distributed processing system may be adopted, in which the respective functions of the machine learning device 100-1 are distributed to a plurality of servers as appropriate. The functions of the machine learning device 100-1 may be realized by utilizing a virtual server function, or the like, in a cloud. When there is a plurality of machine learning devices 100-1 to 100-n respectively corresponding to a plurality of servo control devices 300-1 to 300-n of the same type name, the same specification, or the same series, the machine learning devices 100-1 to 100-n may be configured to share the learning results in the machine learning devices 100-1 to 100-n. By doing so, a further optimal model can be constructed.

### EXPLANATION OF REFERENCE NUMERALS

10, 10A, 10B control device
100, 110 machine learning device
200, 200A, 210 output device
211 information acquisition unit
212 information output unit
213 drawing unit
214 operation unit
215 control unit
216 storage unit
217 information acquisition unit
218 information output unit
219 display unit
220 operation unit
300, 310 servo control device
400, 410 servo motor
500 adjustment device
600 network

What is claimed is:

1. An output device comprising: an information acquisition unit which acquires, from a machine learning device that performs machine learning on a servo control device for controlling a servo motor driving an axis of a machine tool, a robot or an industrial machine, a parameter or a first physical quantity of a constituent element of the servo control device that is being learned or has been learned; and
an output unit which outputs at least one of any one of the acquired first physical quantity and a second physical quantity determined from the acquired parameter, a time response characteristic of the constituent element of the servo control device and a frequency response characteristic of the constituent element of the servo control device,
wherein the time response characteristic and the frequency response characteristic are determined with the parameter, the first physical quantity or the second physical quantity.

2. The output device according to claim 1, wherein the output unit includes a display unit which displays, on a display screen, the first physical quantity, the second physical quantity, the time response characteristic or the frequency response characteristic.

3. The output device according to claim 1, wherein an instruction to adjust the parameter or the first physical quantity of the constituent element of the servo control device based on the first physical quantity, the second physical quantity, the time response characteristic or the frequency response characteristic is provided to the servo control device.

4. The output device according to claim 1, wherein a machine learning instruction to perform, by changing or selecting a learning range, the machine learning of the parameter or the first physical quantity of the constituent element of the servo control device based on the first physical quantity, the second physical quantity, the time response characteristic or the frequency response characteristic is provided to the machine learning device.

5. The output device according to claim 1, wherein an evaluation function value which is used in the learning of the machine learning device is output.

6. The output device according to claim 1, wherein information on a position error which is output from the servo control device is output.

7. The output device according to claim 1, wherein the parameter of the constituent element of the servo control device is a parameter of a mathematical formula model or a filter.

8. The output device according to claim 7, wherein the mathematical formula model or the filter is included in a velocity feedforward processing unit or a position feedforward processing unit, and the parameter includes a coefficient in a transfer function of the filter.

9. A control device comprising: the output device according to claim 1;
the servo control device which controls the servo motor that drives the axis of the machine tool, the robot or the industrial machine; and
the machine learning device which performs the machine learning on the servo control device.

10. The control device according to claim 9, wherein the output device is included in one of the servo control device and the machine learning device.

11. A method of outputting a learning parameter of an output device which is machine learned in a machine learning device for a servo control device that controls a servo motor for driving an axis of a machine tool, a robot or an industrial machine, the method comprising:
acquiring, from the machine learning device, a parameter or a first physical quantity of a constituent element of the servo control device which is being learned or has been learned;
outputting at least one of any one of the acquired first physical quantity and a second physical quantity determined from the acquired parameter, a time response characteristic of the constituent element of the servo control device and a frequency response characteristic of the constituent element of the servo control device; and
determining the time response characteristic and the frequency response characteristic with the parameter, the first physical quantity or the second physical quantity.
